(19) United States
(12) Patent Application Publication
(10) Pub. No.: US 2026/0280618 A1
(43) Pub. Date: Sep. 17, 2026

(54) SYSTEMS AND METHODS FOR GENERATING AND STEERING ORBITAL ANGULAR MOMENTUM ELECTROMAGNETIC BEAMS

(71) Applicant: Huawei Technologies Co., Ltd., Shenzhen (CN)

(72) Inventors: Mohammad Akbari Choubar, Stittsville (CA); Tan Huy Ho, Stittsville (CA)

(21) Appl. No.: 19/667,322

(22) Filed: May 4, 2026

Related U.S. Application Data
(63) Continuation of application No. PCT/CN2023/136126, filed on Dec. 4, 2023.

(51) Int. Cl. H04B 7/0426; H01Q 3/26; H04B 7/0408; H04B 7/22

(52) U.S. Cl. CPC H04B 7/043; H01Q 3/26; H04B 7/0408; H04B 7/22

(57) ABSTRACT

Systems and methods for generating and electronically steering an orbital angular momentum (OAM) electromagnetic beam are disclosed. An example system can include a beamforming device configured to receive a plurality of input signals and output a plurality of beamforming signals by modulating the plurality of input signals in accordance with beamforming phase shifts related to a mode content of the OAM electromagnetic beam. The system can further include a beamsteering device configured to receive the plurality of beamforming signals and output a plurality of beamsteering signals by modulating the plurality of beamforming signals in accordance with beamsteering phase shifts related to steering conditions for the OAM electromagnetic beam. The system can further include an antenna structure that includes a radial waveguide. The radial waveguide includes a base plate and a slot plate defining a waveguide cavity therebetween. The slot plate has a plurality of radiating slots formed therethrough.

### CROSS-REFERENCE TO RELATED APPLICATIONS

This application is a continuation of International Application No. PCT/CN2023/136126, entitled “SYSTEMS AND METHODS FOR GENERATING AND STEERING ORBITAL ANGULAR MOMENTUM ELECTROMAGNETIC BEAMS,” filed on Dec. 4, 2023, which application is hereby incorporated herein by reference in its entirety.

### TECHNICAL FIELD

The technical field generally relates to wireless communications, and more particularly to systems and methods for generating and steering orbital angular momentum (OAM) electromagnetic beams.

### BACKGROUND

Continued growth in the number of mobile device users and the demand for higher data transfer rates and adequate bandwidth capacities in free-space line-of-sight communication links have increased the importance of multimedia services and mobile Internet in wireless communication systems. One method that attempts to address these needs is through space-division multiplexing (SDM), which allows multiple, orthogonal, data-carrying beams to be transmitted at the same time and over the same frequency between a single transceiver pair. According to this method, each beam occupies an individual spatial mode in an orthogonal basis set. SDM can be achieved using mode-division-multiplexing (MDM). One spatial mode basis that has been demonstrated for use of MDM in free-space line-of-sight communication links is that of orbital angular momentum (OAM) modes. An OAM electromagnetic beam includes a phase front with an azimuthally varying phase given by exp(ikφ), where k is the OAM order (k=0, ±1, ±2, . . . ) and φ is the azimuthal angle. For |k|≥1, the phase front according to a helical phase structure as the OAM electromagnetic beam propagates.

Precise alignment between transmitters and receivers in communication systems plays an important role to ensure that adequate signal power is received at the receiver. For OAM multiplexing systems, precise alignment is often of even greater importance since misalignment may lead to crosstalk among channels. Accordingly, a transmitter should be able to both generate and steer OAM electromagnetic beams for active pointing. The few OAM-based beam-scanning systems that have been reported in the literature tend to be complex, costly, manual (non-electronic), and suffer from limited scan range and/or poor radiation performance (e.g. deteriorated side lobe level, insufficient directivity, high loss, low efficiency, and/or poor phase calibration quality). Despite advances in the field, challenges remain in the development of beam generation and steering techniques for OAM electromagnetic beams.

### SUMMARY

The present disclosure generally relates to techniques, including systems and methods, for generating and steering orbital angular momentum (OAM) electromagnetic beams.

The disclosed embodiments generally use a beamforming device, a beamsteering device, a slotted antenna structure. The beamforming device generates beamforming signals modulated in accordance with beamforming phase shifts related to a mode content of the OAM beam. The beamsteering device generates beamsteering signals by modulating beamforming signals in accordance with beamsteering phase shifts related to steering conditions for the OAM beam. The slotted antenna structure is fed with the beamsteering signals to emit the OAM beam. The slotted antenna structure includes at least one slotted radial waveguide azimuthally partitioned into waveguide sectors by partition walls. Waveguide sectorization allows for the OAM beam to be steered by providing the different waveguide sectors with different beamsteering signals associated with different beamsteering phase shifts. Advantageously, the OAM beam may carry a relatively large number of OAM modes and may be steerable through 360° in azimuth and up to 10° in elevation. The disclosed embodiments may be used in both in a transmit mode and a receive mode.

In some embodiments, the radial extent of the partition walls is less than that of the cavity, corresponding to a partial waveguide sectorization. Partial waveguide sectorization can improve the radiation performances of the antenna structure compared to a full waveguide sectorization, for example, in terms of suppressing or at least reducing grating lobes and/or side lobes.

In some embodiments, the antenna structure is provided with multiple sectorized waveguides, whether with partial or full sectorization. In such embodiments, multiple sectorized waveguides may be stacked concentrically in a nested arrangement in order for the radiating surfaces of the multiple sectorized waveguides to be coplanar with each other in order to provide the antenna with a flat radiating surface. Such an arrangement can achieve several advantages compared to a multilevel arrangement of the waveguide's radiating surfaces. Examples of such advantages can include (i) a reduction in unwanted reflections and other radiation performance deterioration caused by near-field interference effects between OAM modes emitted by different waveguides, (ii) an improvement in load impedance uniformity and impedance matching, and (iii) a more compact packaging arrangement

In accordance with an aspect, there is provided a system for generating and steering an OAM electromagnetic beam. The system includes a beamforming device configured to receive a plurality of input signals and output a plurality of beamforming signals by modulating the plurality of input signals in accordance with beamforming phase shifts related to a mode content of the OAM electromagnetic beam. The system also includes a beamsteering device configured to receive the plurality of beamforming signals and output a plurality of beamsteering signals by modulating the plurality of beamforming signals in accordance with beamsteering phase shifts related to steering conditions for the OAM electromagnetic beam. The system further includes an antenna structure having a radial waveguide. The radial waveguide includes a base plate and a slot plate defining a waveguide cavity therebetween. The slot plate has a plurality of radiating slots formed therethrough. The radial waveguide is also partitioned into a plurality of waveguide sectors by a plurality of azimuthally spaced partition walls. Each partition wall extends radially over less than a radial extent of the waveguide cavity, which provides partial waveguide sectorization. Each waveguide sector includes a feed probe connected to the beamsteering device. Each feed probe is configured to introduce a corresponding one of the plurality of beamsteering signals into the waveguide sector and cause the corresponding beamsteering signal to radiate through a number of the radiating slots corresponding to the waveguide sector. The output from all the waveguide sectors generates the OAM electromagnetic beam.

In accordance with another aspect, there is provided a method of generating and steering an OAM electromagnetic beam. The method includes a step of generating a plurality of beamforming signals by modulating a plurality of input signals in accordance with beamforming phase shifts related to a mode content of the OAM electromagnetic beam. The method also includes a step of generating a plurality of beamsteering signals by modulating the plurality of beamforming signals in accordance with beamsteering phase shifts related to steering conditions for the OAM electromagnetic beam. The method further includes a step of emitting the OAM electromagnetic beam according to the steering conditions by feeding the plurality of beamsteering signals to an antenna structure including a radial waveguide. The radial waveguide includes a base plate and a slot plate defining a waveguide cavity therebetween. The slot plate has a plurality of radiating slots formed therethrough. The radial waveguide is partitioned into a plurality of waveguide sectors by a plurality of azimuthally spaced partition walls. Each partition wall extends radially over less than a radial extent of the waveguide cavity, which provides partial waveguide sectorization. The step of emitting the OAM electromagnetic beam includes introducing a corresponding one of the plurality of beamsteering signals into each waveguide sector to cause the corresponding beamsteering signal to radiate through a number of the radiating slots corresponding to the waveguide sector. The output from all the waveguide sectors generates the OAM electromagnetic beam.

In accordance with another aspect, there is provided a system for generating and steering an OAM electromagnetic beam. The system includes a beamforming device configured to receive a plurality of input signals and output a plurality of beamforming signals by modulating the plurality of input signals in accordance with beamforming phase shifts related to a mode content of the OAM electromagnetic beam. The system also includes a beamsteering device configured to receive the plurality of beamforming signals and output a plurality of beamsteering signals by modulating the plurality of beamforming signals in accordance with beamsteering phase shifts related to steering conditions for the OAM electromagnetic beam.

The system further includes an antenna structure that includes a first radial waveguide and a second radial waveguide. The second radial waveguide azimuthally encloses the first radial waveguide. The first radial waveguide includes a first base plate and a first slot plate defining a first waveguide cavity therebetween. The first slot plate has a plurality of first radiating slots formed therethrough. The first radial waveguide is partitioned into a plurality of first waveguide sectors by a plurality of azimuthally spaced, radially extending first partition walls. Each first waveguide sector includes a first feed probe connected to the beamsteering device and configured to introduce a corresponding one of a first subset of the plurality of beamsteering signals into the first waveguide sector and cause the corresponding beamsteering signal to radiate through a number of the first radiating slots corresponding to the first waveguide sector. The output from all the first waveguide sectors generates a first beam component of the OAM electromagnetic beam.

The second radial waveguide includes a second base plate and a second slot plate defining a second waveguide cavity therebetween. The second slot plate has a plurality of second radiating slots formed therethrough. The second radial waveguide is partitioned into a plurality of second waveguide sectors by a plurality of azimuthally spaced, radially extending second partition walls. Each second waveguide sector includes a second feed probe connected to the beamsteering device and configured to introduce a corresponding one of a second subset of the plurality of beamsteering signals into the second waveguide sector and cause the corresponding beamsteering signal to radiate through a number of the second radiating slots corresponding to the second waveguide sector. The output from all the second waveguide sectors generates a second beam component of the OAM electromagnetic beam. The first slot plate defines a first radiating surface, the second slot plate defines a second radiating surface, and the first radiating surface and the second radiating surface are substantially coplanar with each other. This provides the antenna structure with a substantially flat radiating surface.

In accordance with another aspect, there is provided a method of generating and steering an OAM electromagnetic beam. The method includes a step of generating a plurality of beamforming signals by modulating a plurality of input signals in accordance with beamforming phase shifts related to a mode content of the OAM electromagnetic beam. The method also includes a step of generating a plurality of beamsteering signals by modulating the plurality of beamforming signals in accordance with beamsteering phase shifts related to steering conditions for the OAM electromagnetic beam. The method further includes a step of emitting the OAM electromagnetic beam according to the steering conditions by feeding the plurality of beamsteering signals to an antenna structure that includes a first radial waveguide and a second radial waveguide. The second radial waveguide azimuthally encloses the first radial waveguide.

The first radial waveguide includes a first base plate and a first slot plate defining a first waveguide cavity therebetween. The first slot plate has a plurality of first radiating slots formed therethrough. The first radial waveguide is partitioned into a plurality of first waveguide sectors by a plurality of azimuthally spaced, radially extending first partition walls. The second radial waveguide includes a second base plate and a second slot plate defining a second waveguide cavity therebetween. The second slot plate has a plurality of second radiating slots formed therethrough. The second radial waveguide is partitioned into a plurality of second waveguide sectors by a plurality of azimuthally spaced, radially extending second partition walls. The first slot plate defines a first radiating surface, the second slot plate defines a second radiating surface, and the first radiating surface and the second radiating surface are substantially coplanar with each other. This provides the antenna structure with a substantially flat radiating surface.

The step of emitting the OAM electromagnetic beam includes an operation of introducing a corresponding one of a first subset of the plurality of beamsteering signals into each first waveguide sector to cause the corresponding beamsteering signal to radiate through a number of the first radiating slots corresponding to the first waveguide sector. This generates a first beam component of the OAM electromagnetic beam. The step of emitting the OAM electromagnetic beam also includes an operation of introducing a corresponding one of a second subset of the plurality of beamsteering signals into each second waveguide sector to cause the corresponding beamsteering signal to radiate through a number of the second radiating slots corresponding to the second waveguide sector. This generates a second beam component of the OAM electromagnetic beam.

Other features, aspects, and advantages of the present disclosure will become more apparent upon reading of the following non-restrictive description of specific embodiments thereof, given by way of example only with reference to the appended drawings. Although specific features described in the foregoing summary and in the following detailed description may be described with respect to specific embodiments or aspects, it should be noted that these specific features may be combined with one another unless explicitly stated otherwise herein.

### BRIEF DESCRIPTION OF THE DRAWINGS

FIG. 1 is a schematic block diagram of a system for generating and steering an OAM electromagnetic beam, in accordance with an embodiment.

FIGS. 2A-2G are various schematic views of an antenna structure for use in a system for generating and steering an OAM electromagnetic beam, in accordance with an embodiment. FIG. 2A is a perspective view of the antenna structure. FIG. 2B is a partially exploded perspective view of FIG. 2A. FIG. 2C is a cross-sectional elevation view of FIG. 2A, taken along section line 2C.

FIG. 2D is an enlargement of portion 2D of FIG. 2C. FIG. 2E is a perspective view of the antenna structure, with a top portion removed to illustrate the partial partition wall arrangement of the first radial waveguide. FIG. 2F is a perspective view of the antenna structure, with a top portion removed to illustrate the partial partition wall arrangement of the second radial waveguide.

FIG. 2G is a perspective view of the antenna structure, with a top portion removed to illustrate the waveguide cavity of the central radial waveguide.

FIG. 3 depicts an example of a feed probe arrangement including three concentric circular feed probe arrays concentrically disposed around a central feed probe, in accordance with an embodiment.

FIGS. 4A-4C are various schematic views of an antenna structure for use in a system for generating and steering an OAM electromagnetic beam, in accordance with an embodiment. FIG. 4A is a perspective view of the antenna structure. FIG. 4B is a partially exploded perspective view of FIG. 4A. FIG. 4C is a cross-sectional elevation view of FIG. 4A, taken along section line 4C.

FIG. 5 is a schematic partially exploded perspective view of an antenna structure 108, in accordance with an embodiment.

FIGS. 6A-6C are various schematic views of an antenna structure for use in a system for generating and steering an OAM electromagnetic beam, in accordance with an embodiment. FIG. 6A is a perspective view of the antenna structure. FIG. 6B is a partially exploded perspective view of FIG. 6A. FIG. 6C is a cross-sectional elevation view of FIG. 6A, taken along section line 6C.

FIGS. 7A-7C are various schematic views of an antenna structure for use in a system for generating and steering an OAM electromagnetic beam, in accordance with an embodiment. FIG. 7A is a perspective view of the antenna structure. FIG. 7B is a partially exploded perspective view of FIG. 7A. FIG. 7C is a cross-sectional elevation view of FIG. 7A, taken along section line 7C.

FIGS. 8A-8C are various schematic views of an antenna structure for use in a system for generating and steering an OAM electromagnetic beam, in accordance with an embodiment. FIG. 8A is a perspective view of the antenna structure. FIG. 8B is a partially exploded perspective view of FIG. 8A. FIG. 8C is a cross-sectional elevation view of FIG. 8A, taken along section line 8C.

FIG. 9 is a flow diagram of a method of forming and generating an OAM electromagnetic beam, in accordance with an embodiment.

FIG. 10 is a flow diagram of a method of forming and generating an OAM electromagnetic beam, in accordance with an embodiment.

FIG. 11 shows simulated radiation patterns for several OAM modes (k=±1, ±2, ±3) using a beam generation and steering system in accordance with an embodiment.

FIG. 12 shows simulated radiation patterns for several OAM modes (k=±4, ±6, ±8) using a beam generation and steering system in accordance with an embodiment.

FIGS. 13A-13E show simulated far-field radiation patterns for five different OAM modes (k=+2, +4, +6, +8, +10) using a beam generation and steering system in accordance with an embodiment. For each OAM mode, the simulated radiation patterns have been steered to four different azimuthal angles (φ=0°, 90°, 180°, 360°) without varying the elevation angle θ.

FIGS. 14A-14B show simulated far-field radiation patterns for two different OAM modes (k=±2) using a beam generation and steering system in accordance with an embodiment. For each OAM mode, the simulated radiation patterns have been steered to four different elevation angles (θ=0°, 3°, 6°, 10°) without varying the elevation angle θ.

### DETAILED DESCRIPTION OF ILLUSTRATIVE EMBODIMENTS

The present disclosure generally relates to techniques, which include systems and methods, for generating and steering multimode orbital angular momentum (OAM) electromagnetic beams in wireless communications applications.

The disclosed techniques may find use in various applications, industries, and wireless technologies that may need or benefit from steerable OAM electromagnetic beams for point-to-point wireless communications in either fixed or mobile applications.

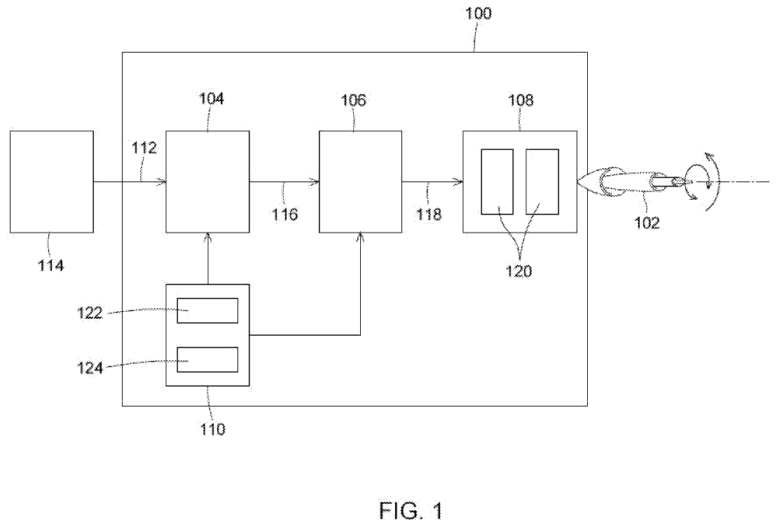

Referring to FIG. 1, there is shown a schematic block diagram of a system 100 for generating and steering an electromagnetic beam 102 carrying one or more OAM modes (an “OAM beam”), in accordance with an embodiment. The system 100 generally includes a beamforming device 104, a beamsteering device 106, an antenna structure 108, and a controller 110. The structure, configuration, and operation of these components and other possible components of, or coupled to, the system 100 are described in greater detail below. It is appreciated that FIG. 1, and likewise for other figures described below, are meant to provide schematic representations that aim to illustrate a number of components and features of the system 100, such that additional components and features that may be useful or necessary for practical operation may not be specifically depicted.

The term “electromagnetic” is intended to refer herein to radiation in any appropriate region of the electromagnetic spectrum. In some embodiments, the OAM beam 102 may have a wavelength ranging from about 0.3 mm to about 300 mm (corresponding to a frequency ranging from about 1 GHz to 1 THz), although other embodiments may operate within other wavelength ranges. In some embodiments, the number of OAM modes carried by the OAM beam 102 may range from one to about twenty, although a greater number of OAM modes is contemplated in other embodiments.

The beamforming device 104 is configured to set the one or more OAM to be carried by the OAM beam 102. The beamforming device 104 includes a number of input ports and a number of output ports. The beamforming device 104 is configured to receive, at its input ports, a plurality of input signals 112. The input signals may be generated by, and received from, an external source 114, such as an electromagnetic wave generator or another suitable device. In some embodiments, the input signals may have the same frequencies but different phases and/amplitudes. The beamforming device 104 is also configured to output, at its output ports, a plurality of beamforming signals 116 by modulating the plurality of input signals 112 in accordance with beamforming phase shifts related to a mode content of the OAM beam 102.

The beamforming device 104 may include one or more Butler matrices. A Butler matrix is a type of beamforming network made of passive devices such as directional couplers and phase shifters. A Butler matrix generally includes M input ports and M output ports, where M is a power of two (e.g., 2, 4, 8, 16, 32, . . . ). For each input signal, the Butler matrix is configured to output M output signals with relative phase shifts between. In the case of simultaneous excitation of m input ports (1<m≤M), the Butler matrix is configured to output a multiplexed compound signal composed of m groups of M output signals. In other embodiments, the beamforming device 104 may be based on other suitable types of beamforming network architectures (e.g. Rotman lenses, Blass matrices, Nolen matrices) operable to modulate the plurality of input signals 112 in order to output the plurality of beamforming signals 116 in accordance with phase-shift schemes related to the OAM modes to be carried by the OAM beam 102 generated by the system 100. It is appreciated that the theory, design, instrumentation, and operation of beamforming networks—including those based on Butler matrices, Rotman lenses, Blass matrices, and Nolen matrices—are generally known in the art and need not be described in detail herein other than to facilitate an understanding of the disclosed techniques.

The beamsteering device 106 is configured to electronically steer (as opposed to mechanically steer) the beam direction of the OAM beam 102 in accordance with beamsteering conditions. The beamsteering device 106 includes a number of input ports and a number of output ports. The input ports of the beamsteering device 106 are coupled with the output ports of the beamforming device 104. The beamsteering device 106 is configured to receive, at its input ports, the plurality of beamforming signals 116 from the beamforming device 104. The beamsteering device 106 is also configured to output, at its output ports, a plurality of beamsteering signals 118. The plurality of beamsteering signals 118 is obtained by modulating the plurality of beamforming signals 118 in accordance with beamsteering phase shifts. The beamsteering phase shifts imposed to the beamsteering signals 118 are related to the steering conditions to be imparted to the OAM beam 102. In some embodiments, setting or adjusting the steering conditions can include setting or adjusting the beam direction within an azimuth angle steering range ranging from about 0° to about 360° and/or setting or adjusting the beam direction within an elevation angle steering range ranging from about 0° to about 10°.

It is appreciated that each beamsteering signal 118 outputted by the beamsteering device 106 has two respective phase shifts associated with it, namely, a first phase shift imparted by the beamforming device 104 and related to the mode content of the OAM beam 102, and a second phase shift imparted by the beamsteering device 106 and related to the steering direction of the OAM beam 102. The plurality of beamsteering signals 118 may, but need not, all have the same amplitude, and likewise for any subset of the beamsteering signals 118.

The beamsteering device 106 may be implemented as a network or array of active or passive, analog or digital, variable phase shifters, or any other suitable type of beamsteering architecture operable to modulate the plurality of beamforming signals 116 received from the beamforming device 104 in order to output the plurality beamsteering signals 118 with relative phase shifts related to the beamsteering conditions to be imparted to the OAM beam 102 generated by the system 100. It is appreciated that the theory, design, instrumentation, and operation of beamsteering devices, including those based on phase-shifter arrays, are generally known in the art and need not be described in detail herein other than to facilitate an understanding of the disclosed techniques.

The antenna structure 108 is configured to receive the plurality of beamsteering signals 118 from the beamsteering device 106 and generate therefrom the OAM beam 102. The antenna structure 108 can include one or more radial waveguides 120. In the case of multiple radial waveguides 120, each radial waveguide is configured to generate a corresponding beam component of the OAM beam 102. Each beam component can carry one or more OAM modes, including zeroth order and non-zeroth order OAM modes.

The or at least one radial waveguide 120 is sectorized into a plurality of waveguide sectors. The number of waveguide sectors for each radial waveguide 120 may range between 4 and 1028. In some embodiments, the number of waveguide sectors may be a power of two (e.g., 2, 4, 8, 16, 32, . . . ), but this is not a requirement. Each waveguide sector of the or each sectorized radial waveguide 120 of the antenna structure 108 is configured to receive a corresponding one of the plurality of beamsteering signals 118 for propagating therein and radiating therefrom, thereby generating a corresponding portion of the OAM beam 102. Waveguide sectorization allows for the OAM beam 102 to be steered. This is because different waveguide sectors having different angular orientations are fed with different beamsteering signals 118 having different beamsteering phase shifts imparted thereto.

The controller 110 is configured to control, monitor, and/or coordinate the operation of various components of, or coupled to the system 100, such as the beamforming device 04 and the beamsteering device 106. The controller 110 may be configured to set or adjust the beamforming phase shifts imparted by the beamforming device 104 on the plurality of input signals 112 to define or change the mode content of the OAM beam 102. The controller 110 may also be configured to set or adjust the beamsteering phase shifts imparted by the beamsteering device 106 on the plurality of beamforming signals 116 to define or change the steering conditions for the OAM beam 102.

The controller 110 may be provided within one or more general-purpose computers or within any other suitable computing devices. The controller 110 may be implemented in hardware, software, firmware, or any combination thereof. The controller 110 may be connected to various components of the system 100 via wired and/or wireless communication links to send and/or receive various types of signals. Non-limiting examples of signals include control signals, timing signals, and data signals. The controller 110 may be controlled by direct user input and/or by programmed instructions. The controller 100 may include an operating system for controlling and managing various functions of the system 100. The controller 100 may be fully or partly integrated with, or physically separate from, the other hardware components system 100. The controller 110 may include a processor 122 and a memory 124. In some embodiments, the controller 110 may be implemented as a field programmable gate arrays (FPGA), an application-specific integrated circuit (ASIC), or a microcontroller.

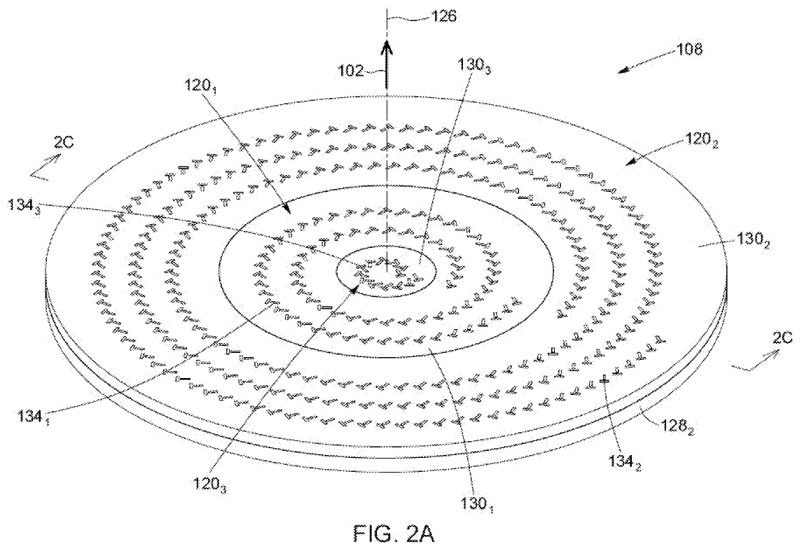

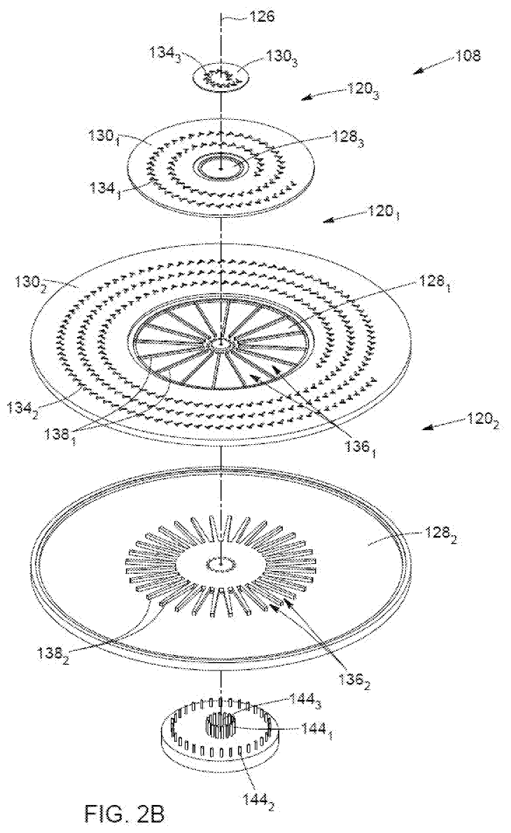

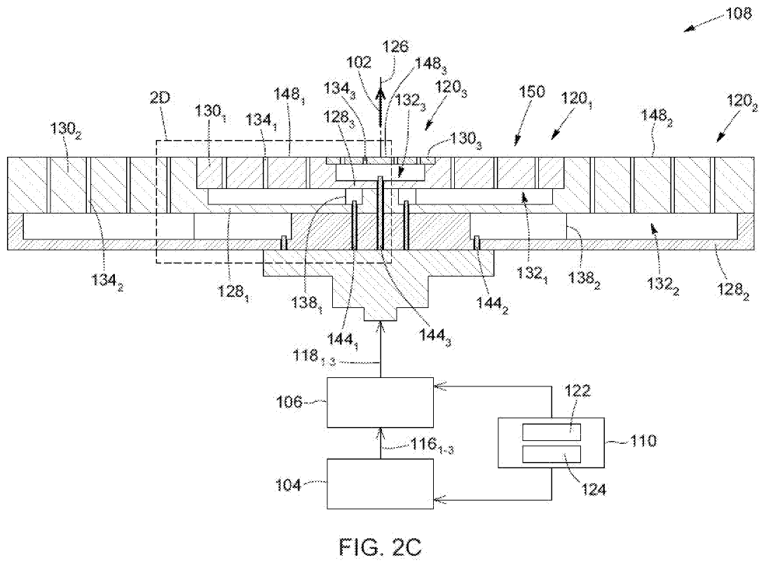

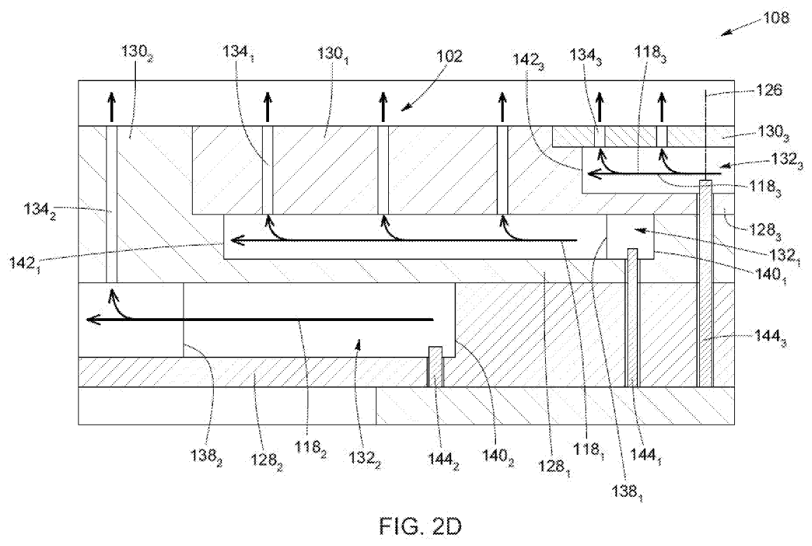

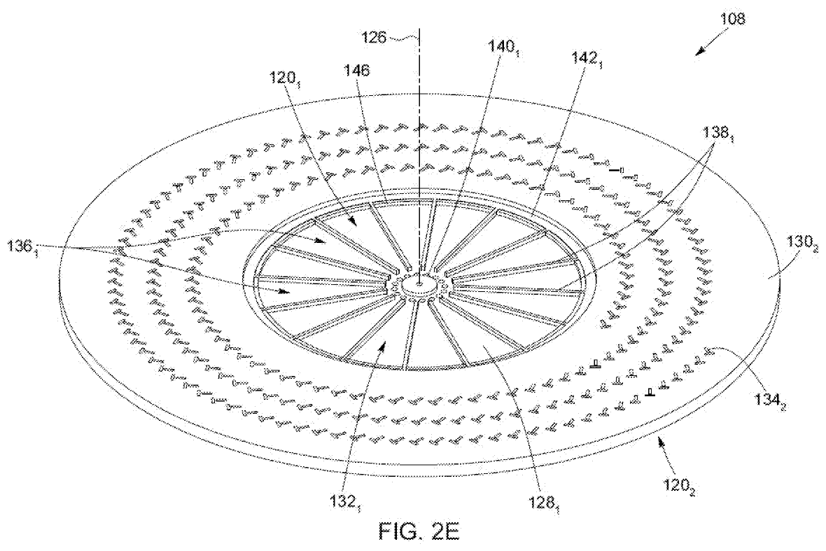

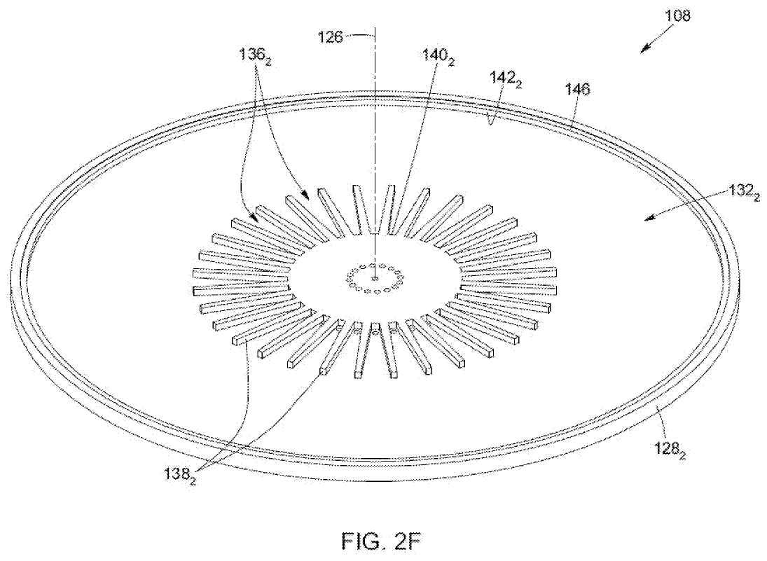

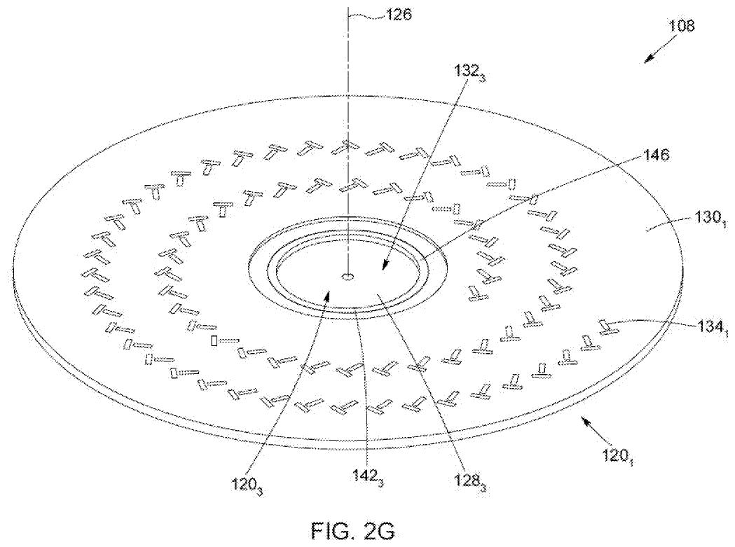

Referring to FIGS. 2A-2G, there are shown various views of an antenna structure 108, in accordance with an embodiment. The antenna structure 108 can be used in a system 100 for generating and steering an OAM beam, such as the one shown in FIG. 1. The antenna structure 108 of FIGS. 2A-2G includes three circular radial waveguides 120₁₋₃, namely, a first radial waveguide 120₁, a second radial waveguide 120₂, and a central radial waveguide 120₃. The three radial waveguides 120₁₋₃ are concentrically stacked about a longitudinal axis 126 of the antenna structure 108, in a nested arrangement with respect to one another. Specifically, the central radial waveguide 120₃ is concentrically nested within the first radial waveguide 120₁, and the first radial waveguide 120₁ is concentrically nested within the second radial waveguide 120₂. Each one of the radial waveguides 120₁₋₃ is configured to operate as a radial line slot array (RLSA) antenna.

It is appreciated that while antenna structure 108 depicted in FIGS. 2A-2G includes three radial waveguides 120₁₋₃, it is contemplated that other embodiments may include fewer or more radial waveguides. For example, a first additional radial waveguide could be provided within which the second radial waveguide 120₂ would be nested, a second additional radial waveguide could be provided within which the first additional radial waveguide would be nested, and so on for any further additional radial waveguide.

In some embodiments, the antenna structure 108 may be configured to output the OAM beam 102 with a circular polarization. In other embodiments, the antenna structure 108 may be configured to output the OAM beam 102 with a linear polarization. The polarization of the OAM beam 102 may be determined by the slot arrangement of the radial waveguides 120₁₋₃.

The first radial waveguide 120₁ includes a first base plate 128₁ and a first slot plate 130₁. The base plate 128₁ and the slot plate 130₁ are spaced apart from each other and define a first waveguide cavity 132₁ therebetween. In some embodiments, the spacing between the base plate 128₁ and the slot plate 130₁, which defines the height of the first waveguide cavity 132₁ may be of the order of about 0.1 mm to about 300 mm. The base plate 128₁ and the slot plate 130₁ may each be made of metal (e.g., aluminum) or another suitable electrically conductive material. The first waveguide cavity 132₁ may be filled with air or any other dielectric material within which the beamsteering signals 118 can propagate with suitably low losses.

The slot plate 120₁ has a plurality of first radiating slots 134₁ formed therethrough. The base plate 128₁ behaves as a ground plane and is devoid of slots formed therein. The number of radiating slots 134₁ in the slot plate 120₁ may range from about 10 to about 1000. The size of the radiating slots 134₁ may be of the order of about a quarter wavelength to about one wavelength. The radiating slots 134₁ may define a plurality of slot pairs. Each slot pair may constitute an elementary radiating element of the first radial waveguide 120₁. In the embodiment of FIGS. 2A-2G, the plurality of radiating slots 134₁ are distributed in a spiral arrangement about the antenna axis 126. In other embodiments, the plurality of radiating slots 134₁ may be distributed in a concentric ring arrangement or any other suitable slot arrangement. The radiating slots 134₁ may or may not all be identically sized and shaped, as desired or required. The number of slots 134₁ as well as the size, shape, orientation, and spatial arrangement of the slots 134₁, are all parameters that can be varied depending on the application.

The first radial waveguide 120₁ is partitioned into a plurality of first waveguide sectors 136₁ by a plurality of azimuthally spaced, radially extending first partition walls 138₁. In the illustrated embodiment, the number of first waveguide sectors 136₁ is 16. The number of first waveguide sectors 136₁ may be different in other embodiments, as noted above. In the illustrated embodiment, the first waveguide sectors 136₁ all have the same azimuthal extent, but this is not a requirement. The first radial waveguide 120₁ is referred to herein as being “partially sectorized”, as opposed to “fully sectorized”. This is because the radial extent of each one of the first partition walls 138₁ is less than the total radial extent of the first waveguide cavity 132₁, which results in partial isolation between the plurality of first waveguide sectors 136₁. In contrast, if the first radial waveguide 120₁ were fully sectorized, the radial extent of each first partition wall 138₁ would be equal to the total radial extent of the first waveguide cavity 132₁. It is noted that the height of the first partition walls 138₁ may be equal to the height of the first waveguide cavity 132₁ under both partial and full sectorization conditions.

In the illustrated embodiment, the first waveguide cavity 132₁ extends radially between an inner edge 140₁ and an outer edge 142₁ of the first radial waveguide 120₁, while each first partition wall 138₁ extends radially from the outer edge 142₁ but terminates at a distance from the inner edge 140₁. However, in other embodiments, each first partition wall 138₁ may instead extend radially from the inner edge 140₁ but terminates at a distance from the outer edge 142₁. In yet other embodiments, other partition wall configurations can be implemented to achieve partial sectorization, for example, partition walls offset from both cavity edges, and multi-segment partition walls.

Referring still to FIGS. 2A-2G, each first waveguide sector 136₁ includes a respective first feed probe 144₁. The feed probe 144₁ may be a coaxial probe, for example, an SMA coaxial feed probe. Each feed probe 144₁ extends inside its corresponding waveguide sector 136₁ via a respective opening formed through the base plate 128₁, in radial proximity to the antenna axis 126 (or at least closer to the inner edge 140₁ than to the outer edge 142₁). The feed probes 144₁ of the first radial waveguide 120₁ may be located at a plurality of evenly spaced first azimuthal positions along a first circular array. Each feed probe 144₁ is connected to a corresponding output port of the beamsteering device 106 to receive therefrom a corresponding one of a first subset of the beamsteering signals 118₁. Each feed probe 144₁ is configured to introduce its corresponding beamsteering signal 118₁ into its corresponding waveguide sector 136₁. The feed probe 144₁ may be configured to convert the electromagnetic power of the beamsteering signal 118₁ from a TEM coaxial mode to a TEM cavity mode. This causes the beamsteering signal 118₁ fed into each first waveguide sector 136₁ to propagate in the radial direction as an outward-directed electromagnetic wave. As the wave propagates from the feed probe 144₁ toward the outer edge 142₁ of the first waveguide cavity 132₁, its power gradually radiates through the radiating slots 134₁ associated with the first waveguide sector 136₁. It follows that the total power radiated from all the first waveguide sectors 136₁ combine to form a first beam component of the OAM beam 102. The OAM mode content and the steering direction of the first beam component are determined by the OAM phase shifts and the beamsteering phase shifts imparted to the first subset of beamsteering signals 118₁, respectively.

The second radial waveguide 120₂ shares several features with the first radial waveguide 120₁. The second radial waveguide 120₂ includes a second base plate 128₂ and a second slot plate 130₂ that are spaced apart from each other and define a second waveguide cavity 132₂ therebetween. The slot plate 130₂ has a cylindrical recess formed therein, within which the first radial waveguide 120₁ may be snuggly inserted. In the illustrated embodiment, the bottom surface of the cylindrical recess provides the top surface of the base plate 128₁ of the first radial waveguide 120₁. The second slot plate 130₂ has a plurality of second radiating slots 134₂ formed therethrough. The base plate 128₂ has no slots formed therein and acts as a ground plane. Due to its larger surface area, the second slot plate 130₂ may include a greater number of radiating slots 134₂ than the first slot plate 130₁, but this is not requirement. The plurality of second radiating slots 134₂ may be distributed in a spiral arrangement about the antenna axis 126 but other slot arrangements are possible, such as a concentric ring arrangement.

The second radial waveguide 120₂ is partitioned into a plurality of second waveguide sectors 136₂ by a plurality of azimuthally spaced, radially extending second partition walls 138₂. In the illustrated embodiment, the number of second waveguide sectors 136₁ is 32. The number of second waveguide sectors 136₁ may be different in other embodiments, as noted above. The number of second waveguide sectors 136₂ may be greater than the number of first waveguide sectors 136₁, but this is not a requirement. In the illustrated embodiment, the second waveguide sectors 136₁ all have the same azimuthal extent, but this is not a requirement. Like the first radial waveguide 120₁, the second radial waveguide 120₁ is partially sectorized. This is because the radial extent of each second partition wall 138₂ is less than the total radial extent of the second waveguide cavity 132₂. The height of the second partition walls 138₂ may be equal to the height of the second waveguide cavity 132₂ under both partial and full sectorization conditions. In the illustrated embodiment, the second waveguide cavity 132₁ extends radially between an inner edge 140₂ and an outer edge 142₂ of the second radial waveguide 120₂, while each second partition wall 138₂ extends radially from the inner edge 140₂ but terminates at a distance from the outer edge 142₂. However, in other embodiments, each second partition wall 138₂ may instead extend radially from the outer edge 142₂ but terminates at a distance from the inner edge 140₂. Other partition wall configurations can be used in other embodiments, as noted above.

It is noted that providing the first and second radial waveguides 120₁₋₂ with a partial sectorized configuration can improve or at least mitigate deterioration in the radiation performances of the antenna structure 108 compared to a full waveguide sectorization, for example, in terms of suppressing or at least reducing grating lobes and/or side lobes.

Each second waveguide sector 136₂ includes a respective second feed probe 144₂. Each feed probe 144₂ extends inside its corresponding waveguide sector 136₂ via a respective opening formed through the base plate 128₂, in radial proximity to the antenna axis 126 (or at least closer to the inner edge 140₂ than to the outer edge 142₂). The feed probes 144₂ of the second radial waveguide 120₂ may be located at a plurality of evenly spaced second azimuthal positions along a second circular array. Each feed probe 144₂ is connected to a corresponding output port of the beamsteering device 106 to receive therefrom a corresponding one of a second subset of the beamsteering signals 118₂. Each feed probe 144₂ is configured to introduce its corresponding beamsteering signal 118₂ into its corresponding waveguide sector 136₂, where beamsteering signal 118₂ is caused to propagate in the radial direction as an outward-directed electromagnetic wave and to gradually radiates its power through the corresponding radiating slots 134₂. It follows that the total power radiated from all the second waveguide sectors 136₂ combine to form a second beam component of the OAM beam 102. The OAM mode content and the steering direction of the second beam component are determined by the OAM phase shifts and the beamsteering phase shifts imparted to the first subset of beamsteering signals 118₂, respectively. In some embodiments, the second beam component may carry one or more second OAM modes of higher order than one or more first OAM modes carried by the first beam component.

The central radial waveguide 120₃ is not sectorized but still shares several features with the first and second radial waveguides 120₁₋₂. The central radial waveguide 120₃ includes a central base plate 128₃ and a central slot plate 130₃ that are spaced apart from each other and define a central waveguide cavity 132₃ therebetween. The slot plate 130₁ of the first radial waveguide 120₁ has a cylindrical recess formed therein, which the central radial waveguide 120₃ may be snuggly inserted. In the illustrated embodiment, the bottom surface of the cylindrical recess provides the top surface of the base plate 128₃ of the central radial waveguide 120₃. The central slot plate 130₂ has a plurality of central radiating slots 134₃ formed therethrough. The base plate 128₃ has no slots formed therein and acts as a ground plane. Due to its smaller surface area, the central slot plate 130₃ may include a smaller number of radiating slots 134₃ than the first and second slot plates 130₁₋₂, but this is not requirement. The plurality of third radiating slots 134₃ may be distributed in a spiral arrangement about the antenna axis 126 but other slot arrangements are possible, such as a concentric ring arrangement.

The central radial waveguide 120₃ includes a feed probe 144₃. The feed probe 144₃ extends coaxially with the antenna axis 126 and protrudes inside the central waveguide cavity 132₃ via a respective opening formed through the base plate 128₃. The feed probe 144₃ is connected to a corresponding output port of the beamsteering device 106 to receive therefrom an unsteering one of the beamsteering signals 118₃. The feed probe 144₃ is configured to introduce the unsteering signal 118₃ inside the central waveguide cavity 132₃ for radial propagation therein as an outward-directed electromagnetic wave. As the wave propagates from the feed probe 144₃ toward the outer edge 142₃ of the central waveguide cavity 132₃, its power gradually radiates through the central radiating slots 134₃ to form a third beam component of the OAM beam 102. Because the central radial waveguide 120₃ is not sectorized and includes a single feed probe 144₃, the third beam component may not be steered and may thus be referred to as an “unsteered” beam component of the OAM beam 102.

In some embodiments, the antenna structure 108 can include one or more electromagnetic-radiation absorbers 146 disposed at various locations within the waveguide cavities 132₁₋₃. The one or more electromagnetic-radiation absorbers 146 are configured to absorb electromagnetic radiation incident thereon and prevent unwanted leakage of electromagnetic energy within or outside the antenna structure. In the embodiment of FIGS. 2A-2G, electromagnetic-radiation absorbers 146 are provided along the outer edges 142₁₋₃ of the radial waveguides 120₁₋₃, but other arrangements are contemplated in other embodiments.

In the embodiment of FIGS. 2A-2G, the beamsteering device 106 is configured to output 49 beamsteering signals 118₁₋₃. The 49 beamsteering signals 118₁₋₃ include: (i) a first subset of 16 beamsteering signals 118₁, which are directed to the 16 feed probes 144₁ of the first radial waveguide 120₁; (ii) a second subset of 32 beamsteering signals 118₂, which are directed to the 32 feed probes 144₂ of the second radial waveguide 120₂; and (ii) a single unsteering signal 118₃, which is directed to the single feed probe 144₃ of the central radial waveguide 120₃. In this embodiment, the beamforming device 104 may be configured to generate: (i) a first subset of 16 beamforming signals 116₁ associated with the first subset of 16 beamsteering signals 118₁ (e.g., using a 16×16 Butler matrix); (ii) a second subset of 32 beamforming signals 1162 associated with the second subset of 32 beamsteering signals 118₂ (e.g., using a 32×32 Butler matrix); and (iii) a single beamforming signal 1163 associated with the single unsteering signal 118₃ (e.g., using a single signal line passing between the two devices 104, 106).

In the embodiment of FIGS. 2A-2G, the top surface of the first slot plate 130₁ defines a first radiating surface 148₁, the top surface of the second slot plate 130₂ defines a second radiating surface 148₂, and the top surface of the central slot plate 130₃ defines a central radiating surface 148₃. Furthermore, the first, second, and central radiating surfaces 148₁₋₃ are substantially coplanar with one another in order to define a flat common radiating surface 150 of the antenna structure. In such an arrangement, the depth of the second radiating slots 134₂ is greater than the depth of the first radiating slots 134₁, and the depth of the first radiating slots 134₁ is greater than the depth of the central radiating slots 134₃.

It is noted that providing the antenna structure 108 with a flat radiating surface 150 by stacking multiple concentric radial waveguides 120₁₋₃ in a nested arrangement can achieve several advantages compared to a multilevel arrangement of the waveguide's radiating surfaces 148₁₋₃. One advantage is that a flat radiating surface 150 can reduce near-field interference in proximity to the antenna axis 126 between the OAM modes (particularly lower-order modes) generated by the larger radial waveguide(s) and the OAM modes generated by the smaller radial waveguide(s). If left uncontrolled, such near-field interference effects can cause unwanted reflections and other radiation performance deterioration. Another advantage of a flat radiating surface 150 is that it can facilitate impedance matching of the feed probes 144₁₋₃. This is because in a single-level arrangement of the waveguide's radiating surfaces 148₁₋₃, all the radiating slots 134₁₋₃ should be exposed to substantially identical environmental conditions. This can increase the uniformity of the load impedance (e.g., 377Ω) across the antenna structure 108 and improve the reflection coefficient of the antenna structure 108. Yet another advantage of a flat radiating surface 150 is that it can provide a more compact arrangement and facilitate packaging. It is noted that the disclosed techniques contemplate flat-radiating-surface antenna structures that include more than two sectorized radial waveguides stacked in a nested arrangement.

In some embodiments, the plurality of second feed probes 144₂ may be azimuthally offset relative to a plurality of first feed probes 144₁. In such embodiments, the plurality of first feed probes 144₁ are located at a plurality of first azimuthal positions, the plurality of second feed probes 144₂ are located at a plurality of second azimuthal positions, and each first azimuthal position is different from each second azimuthal position. The provision of an azimuthal offset between the arrangement of the first feed probes 144₁ and the second feed probes 144₂ can be advantageous in terms of improving or at least mitigating adverse effects in load termination performance. In some embodiments, the azimuthal position φ_{1,n} of the n^{th} first feed probe can be given by 2π(n−1)/N₁, where N₁ is the number of first feed probes 144₁ (e.g., 16 in the illustrated embodiment) in the first radial waveguide, and wherein the n^{th} second azimuthal position φ_{2,n} is given by π(2n−1)/N₂, where N₂ is the number of second feed probes 144₂ (e.g., 32 in the illustrated embodiment). These relationships can be generalized to the case of P>2 concentric circular arrays of feed probes as follows:

$${ϕ}_{p , n} = 2 π ( n - 1 ) / {N}_{p} , for p = 1 , \qquad ( 1 )$$

$${ϕ}_{p , n} = π ( 2 n - 1 ) / {N}_{p} , for 1 < p \leq P , \qquad ( 2 )$$

where φ_{p,n} is the azimuthal position of the n^{th} feed probe of the p^{th} circular array, Nₚ is the total number of feed probes in the p^{th} circular array, and the circular array radius increases as p increases.

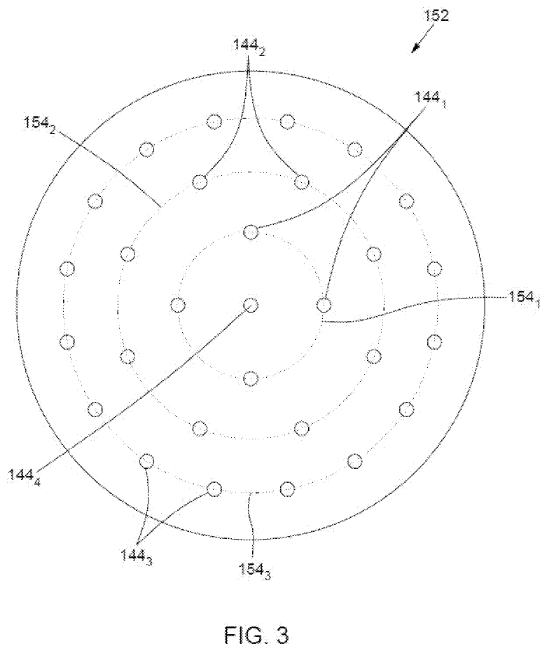

Referring to FIG. 3, there is illustrated an exemplary of three concentric circular feed probe arrays 152 (P=3), where the first probe array 154₁ (p=1) includes four feed probes 144₁ (N₁=4), the second probe array 154₂ (p=2) includes eight feed probes 144₂ (N₂=8), and the third probe array 154₃ (p=3) includes sixteen feed probes 144₃ (N₃=16). FIG. 3 also includes a single feed probe 144₄ located at the center of the feed probe arrays 152.

In some embodiments, waveguide sectorization, whether partial or full, can result in less-than-optimal operation. For example, waveguide sectorization can generate unwanted grating lobes that can undesirably or adversely impact the radiation performance of the antenna structure 108. In some embodiments, such potential issues or limitations can be overcome or mitigated using different approaches. Non-limiting examples of such approaches may include (i) moving the feed probes 144₁₋₂ of the sectorized radial waveguides 120₁₋₂ further from the antenna axis 126; (ii) moving the radiating slots 134₁₋₂ of the sectorized radial waveguides 120₁₋₂ closer to the antenna axis 126; (iii) increasing the number of feed probes 144₁₋₂ in each sectorized radial waveguide 120₁₋₂; and (iv) increasing the number of radiating slots 134₁₋₂ in each waveguide sector 136₁₋₂.

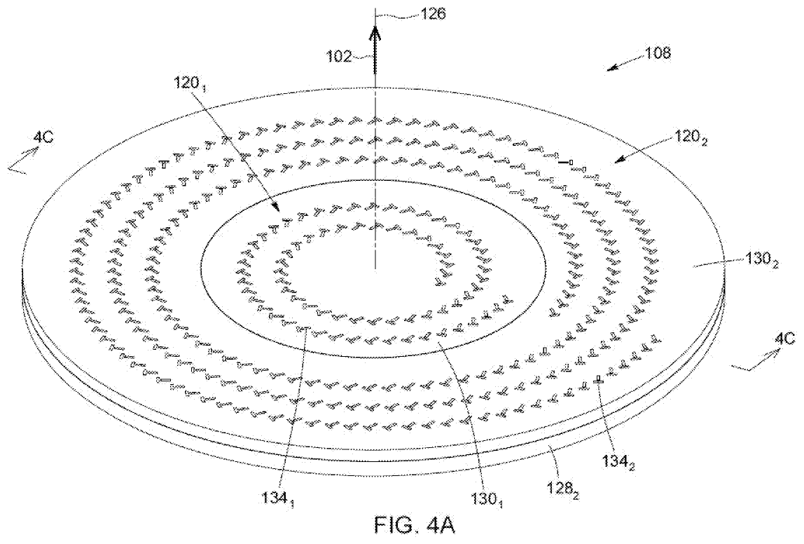

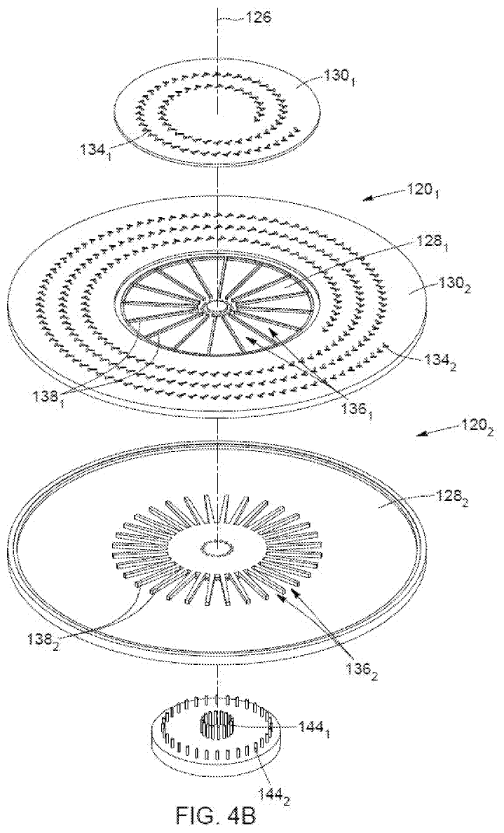

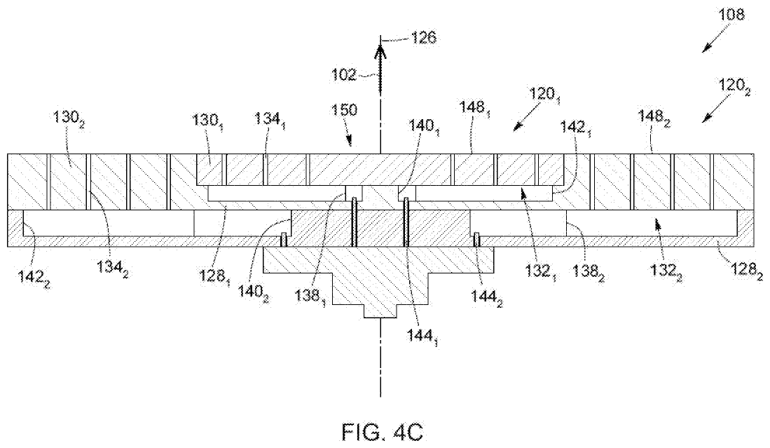

Various other embodiments will be now described with reference to FIGS. 4A-4C, 5, 6A-6C, 7A-7C, and 8A-8C. Each of these embodiments depicts an antenna structure 108 that can be used in a system 100 for generating and steering an OAM electromagnetic beam, such as the one shown in FIG. 1. Each of these embodiments shares several features with previously described embodiments but differ in certain respects. Such shared features will not be described in detail again other than to highlight their differences.

FIGS. 4A-4C are different views of an antenna structure 108, in accordance with an embodiment. The antenna structure 108 of FIGS. 4A-4C differs from the antenna structure 108 of FIGS. 2A-2G in that it does not include a central radial waveguide nested within the first radial waveguide 120₁ and configured to generate an unsteered beam component (e.g., a zeroth-order OAM beam component).

It is noted that the antenna structures 108 shown in FIGS. 2A-2G and 4A-4C include both: (i) a flat radiating surface 150 combining the radiating surfaces 148₁₋₂ of at least two sectorized radial waveguides 120₁₋₂; and (ii) partially sectorized radial waveguides 120₁-120₂. However, embodiments that use either one of these two features, but not both, are contemplated by the present disclosure. Non-limiting examples of such embodiments are described below.

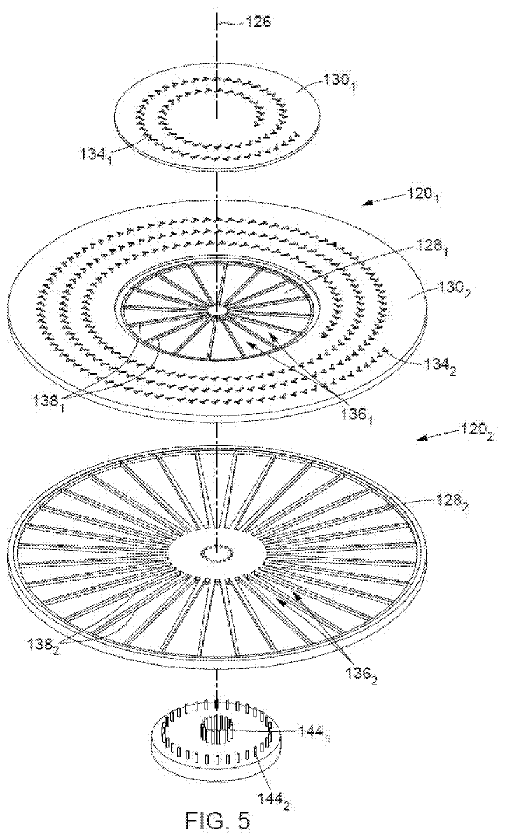

FIG. 5 is a partially exploded perspective view of an antenna structure 108, in accordance with an embodiment. In contrast to the antenna structure 108 of FIGS. 2A-2G, the first and second radial waveguides 120₁₋₂ of the antenna structure of FIG. 5 are fully, rather than partially, sectorized. Specifically, the first radial waveguide 120₁ is partitioned into a plurality of first waveguide sectors 136₁ by a plurality of azimuthally spaced extending first partition walls 138₁, and the second radial waveguide 120₂ is partitioned into a plurality of second waveguide sectors 136₂ by a plurality of azimuthally spaced extending second partition walls 138₂. The radial extent of each first partition wall 138, is equal to the total radial extent of the first waveguide cavity 132₁, and the radial extent of each second partition wall 138₂ is equal to the total radial extent of the second waveguide cavity 132₂.

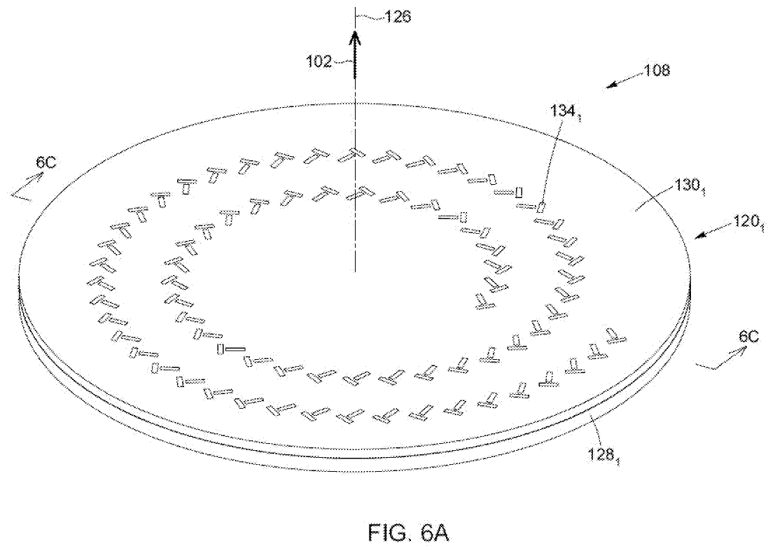

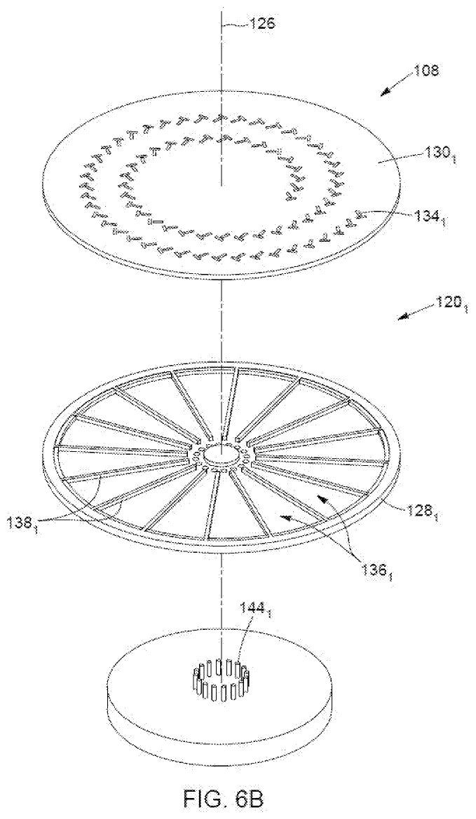

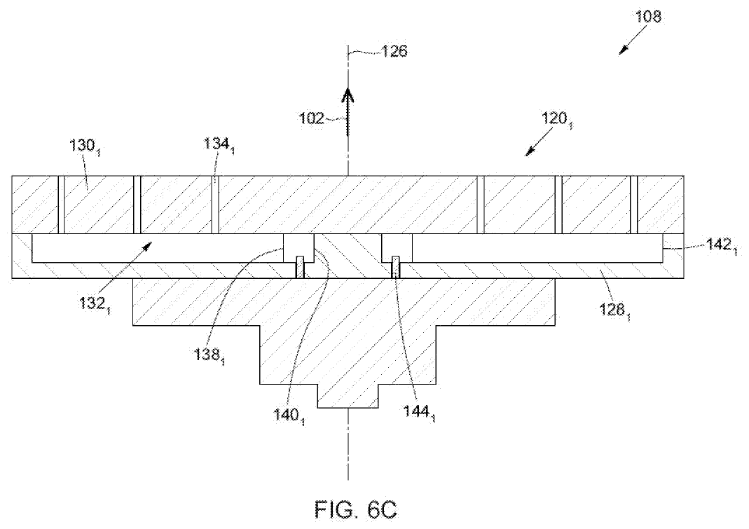

FIGS. 6A-6C, 7A-7C, and 8A-8B depict three other embodiments of an antenna structure 108. In each of these three embodiments, the antenna structure 108 includes a partially sectorized first radial waveguide 120₁ but does not include a flat radiating surface combining the radiating surfaces of at least two (partially or fully) sectorized radial waveguides.

In FIGS. 6A-6C, the antenna structure 108 includes a single radial waveguide, namely a first radial waveguide 120₁ with partial sectorization.

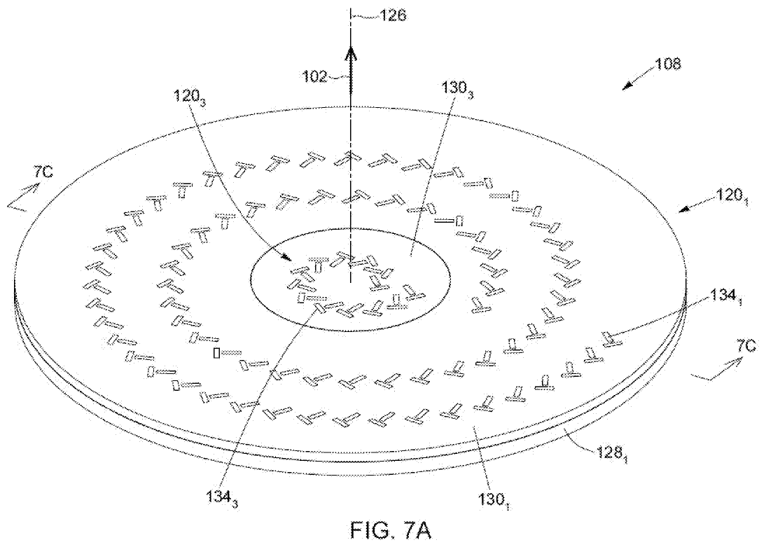

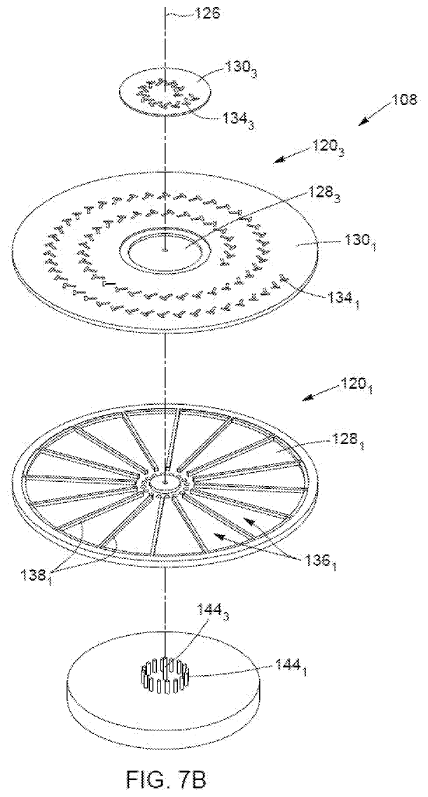

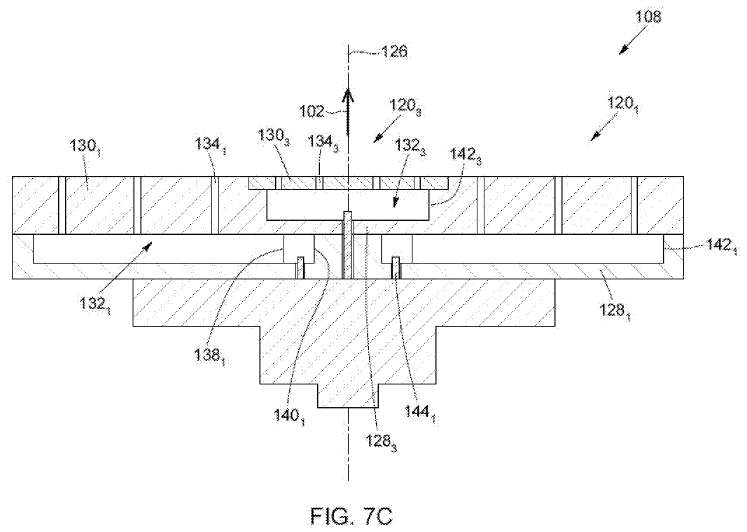

In FIGS. 7A-7C, the antenna structure 108 includes a first radial waveguide 120₁ with partial sectorization, and a central radial waveguide 120₃ nested within the first radial waveguide 120₁. In this embodiment, the radiating surface 148₁ of the first radial waveguide 120₁ and the radiating surface 148₃ of the central radial waveguide 120₃ are substantially coplanar with each other.

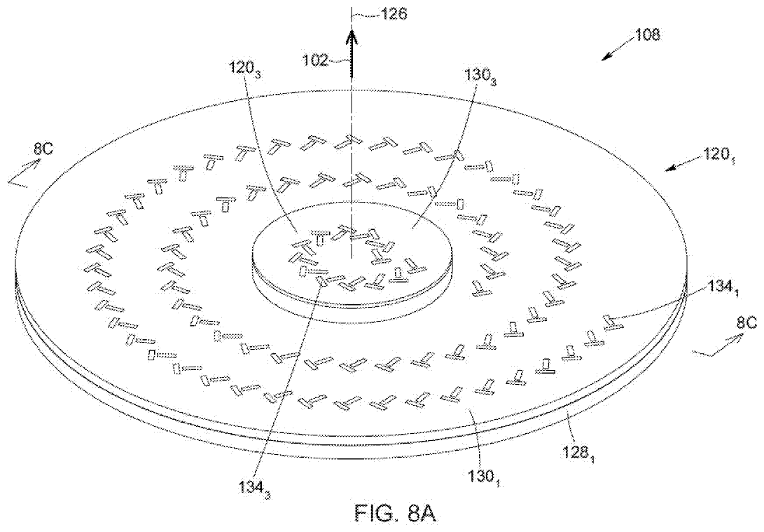

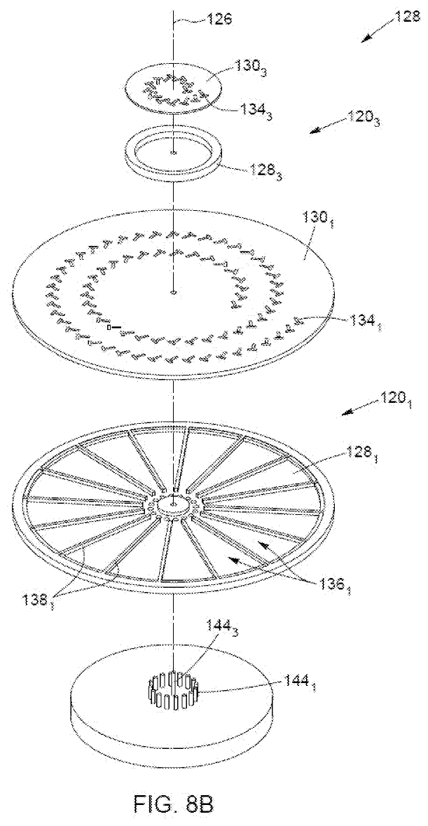

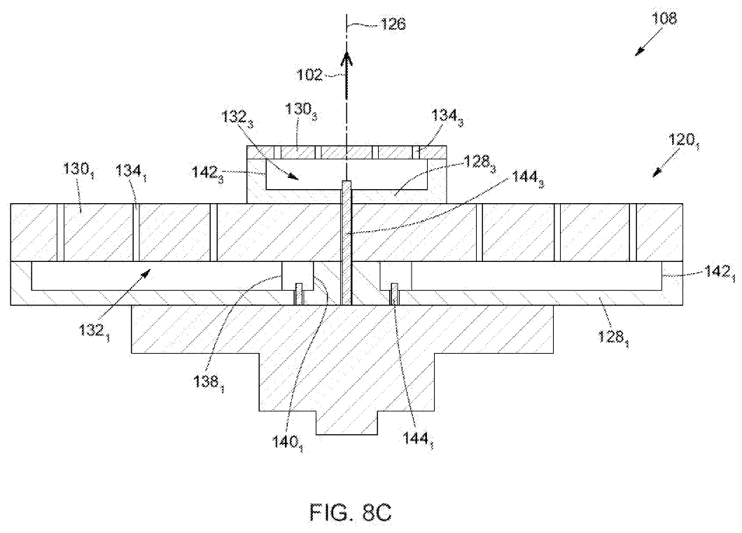

In FIGS. 8A-8C, the antenna structure 108 includes a first radial waveguide 120₁ with partial sectorization, and a central radial waveguide 120₃ stacked on top of the first radial waveguide 120₁ in a multilevel arrangement. In this embodiment, the radiating surface 148₁ of the first radial waveguide 120₁ and the radiating surface 148₃ of the central radial waveguide 120₃ are not coplanar with each other.

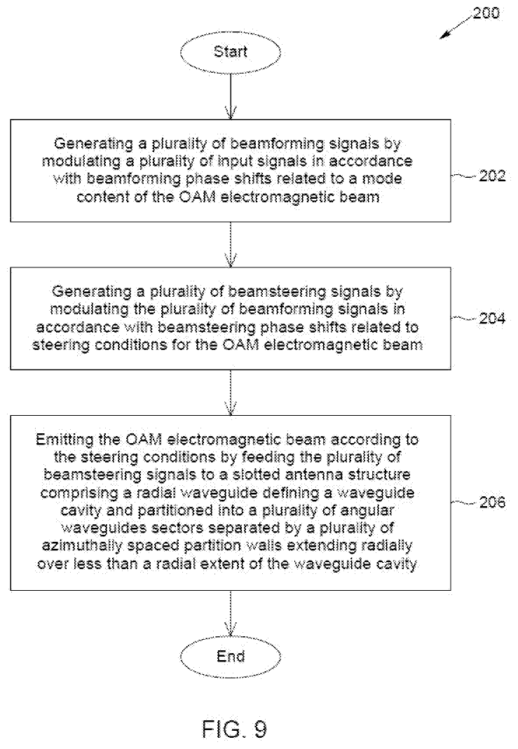

Referring to FIG. 9, there is illustrated a flow diagram of a method 200 of generating and steering an OAM beam. The method 200 of FIG. 9 may be implemented in a system such as those described above, or another suitable system. It is noted that the method 200 may share many features similar to those described with respect to the structure, configuration, and operation of system implementations. Such similar features need not be described again below.

The method 200 includes a step 202 of generating a plurality of beamforming signals by modulating a plurality of input signals in accordance with beamforming phase shifts related to a mode content of the OAM beam. In some embodiments, the generating step 202 includes an operation of adjusting the beamforming phase shifts to change the mode content of the OAM beam.

The method 200 also includes a step 204 of generating a plurality of beamsteering signals by modulating the plurality of beamforming signals in accordance with beamsteering phase shifts related to steering conditions for the OAM beam. In some embodiments, the generating step 204 includes an operation of adjusting the beamsteering phase shifts to change the steering conditions for the OAM beam. In some embodiments, the steering conditions may be set or adjusted within an azimuth angle steering range ranging from about 0° to about 360° and/or within an elevation angle steering range ranging from about 0° to about 10°.

The method 200 further includes a step 206 of emitting the OAM beam according to the steering conditions by feeding the plurality of beamsteering signals to an antenna structure. The antenna structure includes a radial waveguide defining a waveguide cavity and having a slot plate with a plurality of radiating slots formed therethrough. The radial waveguide is partitioned into a plurality of angular waveguide sectors by a plurality of partition walls. Each partition wall extends radially over less than a radial extent of the waveguide cavity, thereby providing partial waveguide sectorization. The emitting step 206 includes an operation of introducing a corresponding one of the beamsteering signals into each waveguide sector to cause the corresponding beamsteering signal to radiate through a number of the radiating slots corresponding to the waveguide sector, thereby generating the OAM beam.

In some embodiments, the radial waveguide is a first radial waveguide configured to generate a first beam component of the emitted OAM beam from a first subset of the beamsteering signals, and the antenna structure further includes a second radial waveguide azimuthally enclosing the first radial waveguide. The second radial waveguide defines a waveguide cavity and has a slot plate with a plurality of radiating slots formed therethrough. The second radial waveguide is partitioned into a plurality of angular waveguide sectors by a plurality of partition walls. Each partition wall extends radially over less than a radial extent of the waveguide cavity. In such embodiments, the emitting step 206 may further include an operation of introducing a corresponding one of a second subset of the beamsteering signals into each waveguide sector of the second radial waveguide to cause the corresponding beamsteering signal to radiate through a number of the radiating slots of the second radial waveguide corresponding to the waveguide sector, thereby generating a second beam component of the emitted OAM beam. In some embodiment, the slot plate of the first radial waveguide defines a first radiating surface, and the slot plate of the second radial waveguide defines a second radiating surface. In such embodiments, the method 200 may further include an operation of providing the first radiating surface and the second radiating surface in a substantially coplanar arrangement.

In some embodiments, the radial waveguide is a first radial waveguide configured to generate a first beam component of the emitted OAM beam, and the antenna structure further includes a central radial waveguide nested within the first radial waveguide. The central radial waveguide defines a waveguide cavity and has a slot plate having a plurality of radiating slots formed therethrough. In such embodiments, the emitting step 206 may further include an operation introducing a corresponding one of the beamsteering signals into the central radial waveguide to cause the corresponding beamsteering signal to radiate through the radiating slots of the central radial waveguide and generate an unsteered beam component of the emitted OAM beam. In some embodiments, the unsteered beam component of the OAM beam is a zeroth-order OAM mode.

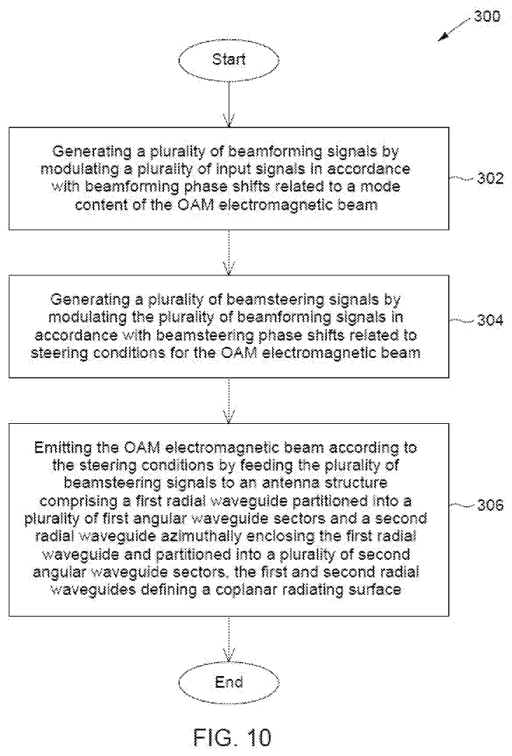

Referring to FIG. 10, there is illustrated a flow diagram of another method 300 of generating and steering an OAM beam. The method 300 of FIG. 10 may be implemented in a system such as those described above, or another suitable system. It is noted that the method 300 may share many features similar to those described with respect to the structure, configuration, and operation of system implementations. Such similar features need not be described again below.

The method 300 includes a step 302 of generating a plurality of beamforming signals by modulating a plurality of input signals in accordance with beamforming phase shifts related to a mode content of the OAM beam. In some embodiments, the generating step 302 includes an operation of adjusting the beamforming phase shifts to change the mode content of the OAM beam.

The method 300 also includes a step 304 of generating a plurality of beamsteering signals by modulating the plurality of beamforming signals in accordance with beamsteering phase shifts related to steering conditions for the OAM beam. In some embodiments, the generating step 304 includes an operation of adjusting the beamsteering phase shifts to change the steering conditions for the OAM beam. In some embodiments, the steering conditions may be set or adjusted within an azimuth angle steering range ranging from about 0° to about 360° and/or within an elevation angle steering range ranging from about 0° to about 10°.

The method 300 further includes a step 306 of emitting the OAM beam according to the steering conditions by feeding the plurality of beamsteering signals to an antenna structure such as described above. The antenna structure includes a first radial waveguide and a second radial waveguide. The second radial waveguide azimuthally encloses the first radial waveguide. The first radial waveguide includes a first base plate and a first slot plate defining a first waveguide cavity therebetween. The first slot plate has a plurality of first radiating slots formed therethrough. The first radial waveguide is partitioned into a plurality of first waveguide sectors by a plurality of azimuthally spaced, radially extending first partition walls. The second radial waveguide includes a second base plate and a second slot plate defining a second waveguide cavity therebetween. The second slot plate has a plurality of second radiating slots formed therethrough. The second radial waveguide is partitioned into a plurality of second waveguide sectors by a plurality of azimuthally spaced, radially extending second partition walls. The first slot plate defines a first radiating surface, and the second slot plate defines a second radiating surface, The first radiating surface and the second radiating surface are substantially coplanar with each other. The emitting step 306 includes a first operation and a second operation. The first operation includes introducing a corresponding one of a first subset of the beamsteering signals into each first waveguide sector to cause the corresponding beamsteering signal to radiate through a number of the first radiating slots corresponding to the first waveguide sector. The first operations generate a first beam component of the OAM beam. The second operation includes introducing a corresponding one of a second subset of the beamsteering signals into each second waveguide sector to cause the corresponding beamsteering signal to radiate through a number of the second radiating slots corresponding to the second waveguide sector. The second operation generates a second beam component of the OAM beam.

In some embodiments, the method 300 includes an operation of setting or adjusting the mode content of the OAM beam to provide that the second beam component carries one or more second OAM modes of higher order than one or more first OAM modes carried by the first beam component.

In some embodiments, each first partition wall extends radially over less than a radial extent of the first waveguide cavity to provide partial isolation between the plurality of first waveguide sectors, and/or each second partition wall extends radially over less than a radial extent of the second waveguide cavity to provide partial isolation between the plurality of second waveguide sectors.

In some embodiments, the antenna structure further includes a central radial waveguide nested within the first radial waveguide. The central radial waveguide defines a central waveguide cavity therebetween and includes a central slot plate having a plurality of central radiating slots formed therethrough. The central slot plate defines a central radiating surface that is substantially coplanar with the first radiating surface and the second radiating surface. In such embodiments, the emitting step 306 may further include an operation of introducing a corresponding one of the beamsteering signals into the central radial waveguide to cause the corresponding beamsteering signal to radiate through the central radiating slots and generate an unsteered beam component of the emitted OAM beam. In some embodiments, the unsteered component may be a zeroth-order OAM mode.

The following description reports computations and numerical simulations conducted to study and investigate certain aspects of the disclosed embodiments. It is appreciated that the systems and methods disclosed herein may have a number of features, variations, and applications. As such, the following description is provided to further illustrate some aspects and capabilities of the techniques disclosed, but should not be construed as in any way limiting their scope.

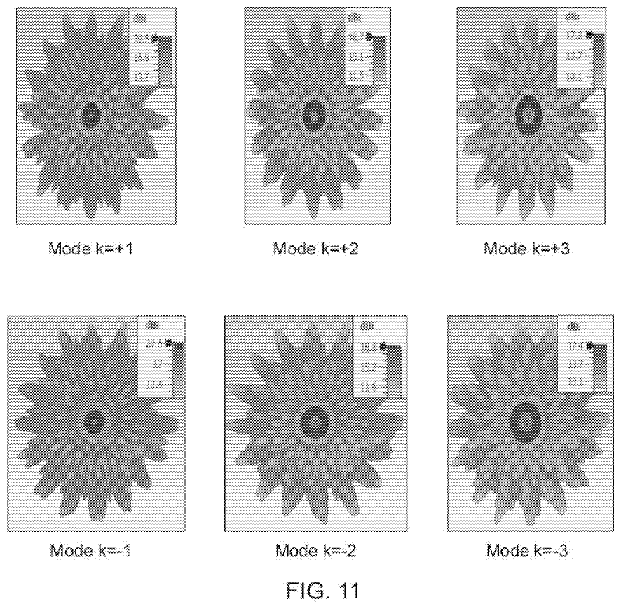

FIG. 11 shows simulated radiation patterns for several OAM modes (k=±1, ±2, ±3) obtained using a beam generation and system in accordance with an embodiment. The system has an antenna structure similar to the one depicted in FIGS. 2A-2G that includes a first partially sectorized radial waveguide, a second partially sectorized radial waveguide, and a central radial waveguide concentrically stacked in a nested arrangement. The OAM modes shown in FIG. 11 are generated by the first radial waveguide, which is azimuthally partitioned into 16 waveguide sectors.

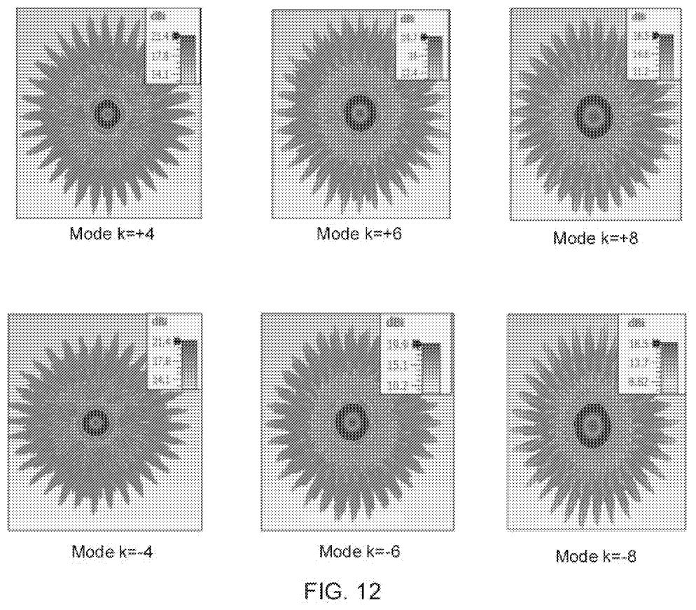

FIG. 12 shows simulated radiation patterns for several OAM modes (k=±4, ±6, ±8) obtained using a beam generation and system in accordance with an embodiment. The system has an antenna structure similar to the one depicted in FIGS. 2A-2G that includes a first partially sectorized radial waveguide, a second partially sectorized radial waveguide, and a central radial waveguide concentrically stacked in a nested arrangement. The OAM modes shown in FIG. 12 are generated by the second radial waveguide, which is azimuthally partitioned into 32 waveguide sectors.

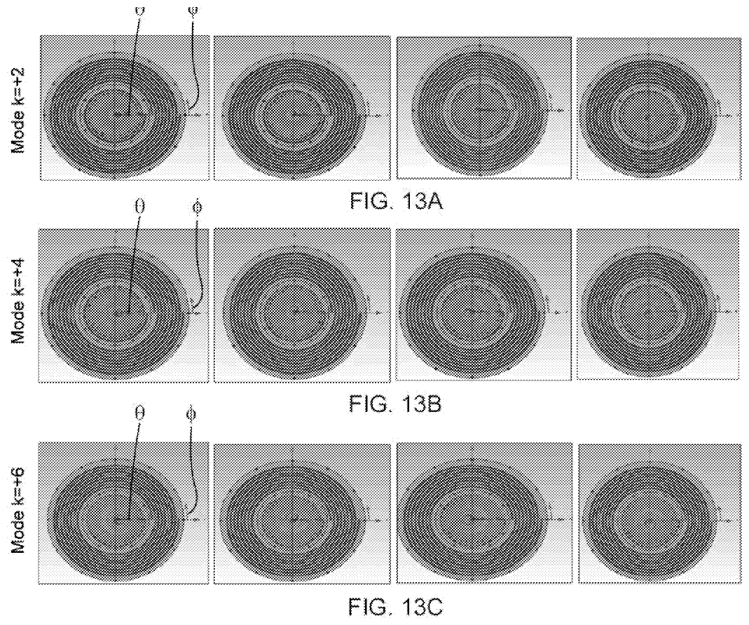

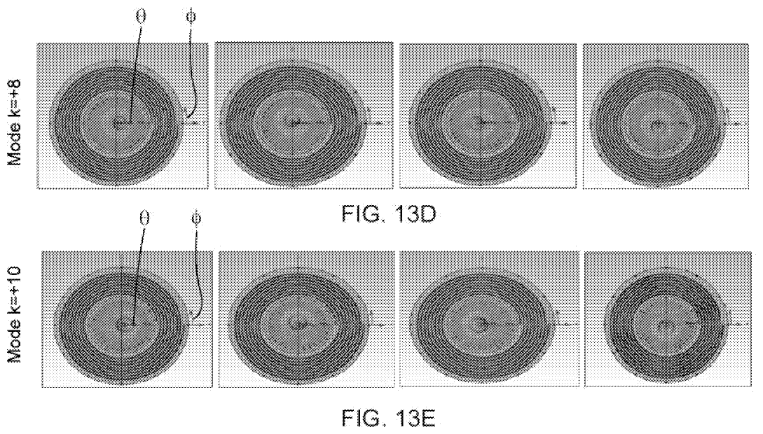

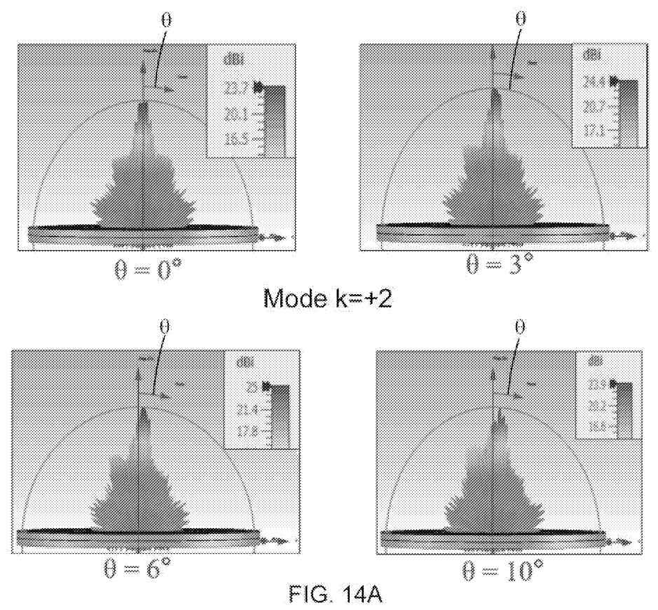

FIGS. 13A-13E show simulated far-field radiation patterns for five different OAM modes (k=+2, +4, +6, +8, +10) using a beam generation and steering system in accordance with an embodiment. The system has an antenna structure similar to the one depicted in FIGS. 2A-2G that includes a first partially sectorized radial waveguide, a second partially sectorized radial waveguide, and a central radial waveguide concentrically stacked in a nested arrangement. The OAM modes shown in FIGS. 13A-13E are generated by the second radial waveguide, which is azimuthally partitioned into 32 waveguide sectors. For each OAM mode, the simulated radiation patterns have been steered to four different azimuthal angles (φ=0°, 90°, 180°, 360°) without varying the elevation angle θ.

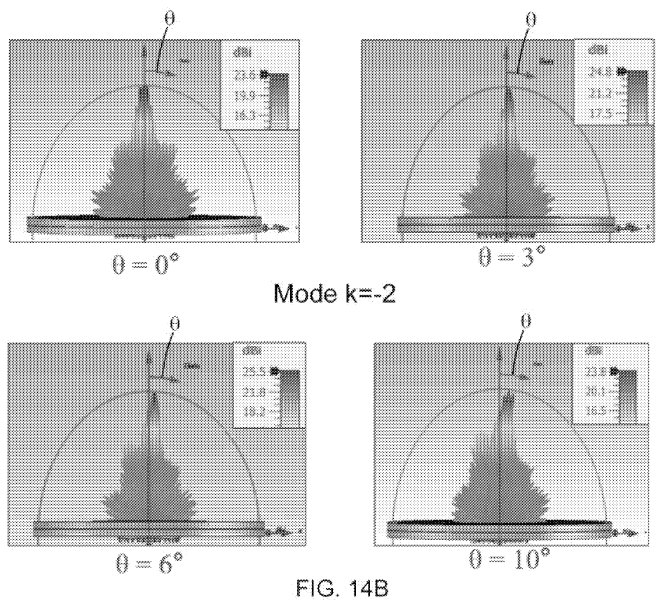

FIGS. 14A-14B show simulated far-field radiation patterns for two different OAM modes (k=±2) using a beam generation and steering system in accordance with an embodiment. The system has an antenna structure similar to the one depicted in FIGS. 2A-2G that includes a first partially sectorized radial waveguide, a second partially sectorized radial waveguide, and a central radial waveguide concentrically stacked in a nested arrangement. The OAM modes shown in FIGS. 14A-14B are generated by the second radial waveguide, which is azimuthally partitioned into 32 waveguide sectors. For each OAM mode, the simulated radiation patterns have been steered to four different elevation angles (θ=0°, 3°, 6°, 10°) without varying the elevation angle θ.

The term “processor” as used herein is intended to refer broadly to any electronic device, circuitry, or component capable of processing, receiving, or transmitting data or instructions, such as computer programs, commands, functions, processes, software codes, executables, applications, and the like. The term “processor” is meant to include a single processor or a single processing unit, multiple processors or multiple processing units, or other suitably configured processing element or elements. Where a processor includes a plurality of processing elements, the processing elements may all be located at one site, or they may be distributed across multiple sites and interconnected by a communication network. Examples communication networks include a local area network (LAN) and a wide area network (WAN), such as, the Internet. Non-limiting examples of a processor include a general-purpose single- or multi-core processor; a central processing unit (CPU); a microprocessor; a controller; a microcontroller; a digital signal processor (DSP); a programmable logic device; a field-programmable gate array (FPGA); an application-specific integrated circuit (ASIC); a digital processor or circuit; an analog processor or circuit; state machine; and/or any other device capable of processing information.

The term “memory” as used herein is intended to refer broadly to any electronic device, circuitry, or component capable of storing electronic data or information. In some instances, the term “memory” may be used interchangeably with the term “computer readable storage medium”. The term “memory” is meant to include a single memory or a single memory unit, multiple memories or multiple memory units, or other suitably configured memory element or elements. Where a memory includes a plurality of memory elements, the memory elements may all be located at one site, or they may be distributed across multiple sites and interconnected by a communication network. Non-limiting examples of a memory include a random-access memory (RAM) of any type; a read-only memory (ROM) of any type; a magnetic storage device; an optical storage device; a solid-state drive (SSD) device, such as a flash drive memory; or any other tangible and/or non-transitory computer readable medium which can be used to store electronic data or information.

In the present disclosure, similar elements in the drawings have been given similar reference numerals. For clarity and ease of illustration, some elements may not be identified in a certain figure if they are already identified in another figure. The elements of the drawings are not necessarily depicted to scale. Positional descriptors indicating the arrangement of one element should be taken in the context of the figures and should not be considered limiting.

The terms “a”, “an”, and “one” are defined herein to mean “one or more”, that is, these terms do not exclude a plural number of elements, unless explicitly stated otherwise herein. The term “or” is defined herein to mean “and/or”, unless explicitly stated otherwise herein.

The expressions “at least one of A, B, and C”, “one or more of A, B, and C”, or any other variant thereof, are understood to include A alone, B alone, and C alone, a combination of A and B, a combination of A and C, a combination of B and C, or a combination of A, B, and C.

Terms such as “substantially”, “generally”, “approximately”, “about”, or any other variant thereof, which modify a value, condition, or characteristic of a feature of an aspect or embodiment disclosed herein, should be understood to mean that the value, condition, or characteristic is defined within tolerances that are acceptable for the proper operation of this aspect or embodiment and/or that fall within an acceptable range of experimental error. In particular, the term “about” generally refers to a range of numbers that one skilled in the art would consider equivalent to the stated value (e.g., having the same or an equivalent function or result). In some cases, the term “about” means a variation within ±10% of the stated value. It is noted that all numeric values used herein are assumed to be modified by the term “about”, unless otherwise stated or dictated by context.

The terms “connected” and “coupled”, and derivatives and variants thereof, refer herein to any connection or coupling, either direct or indirect, between two or more elements, unless otherwise stated or dictated by context. For example, the connection or coupling between the elements may be mechanical, optical, electrical, magnetic, thermal, chemical, logical, fluidic, operational, or any combination thereof.

Numerous modifications could be made to the features of any embodiments described herein without departing from the scope of the appended claims. Furthermore, any feature of any embodiment disclosed herein can be combined or used with any feature of any other embodiment disclosed herein, unless otherwise stated or dictated by context.

What is claimed is:

1. A system for generating and steering an orbital angular momentum (OAM) electromagnetic beam, comprising:
a beamforming device configured to receive a plurality of input signals and output a plurality of beamforming signals by modulating the plurality of input signals in accordance with beamforming phase shifts related to a mode content of the OAM electromagnetic beam;
a beamsteering device configured to receive the plurality of beamforming signals and output a plurality of beamsteering signals by modulating the plurality of beamforming signals in accordance with beamsteering phase shifts related to steering conditions for the OAM electromagnetic beam; and
an antenna structure comprising a first radial waveguide, the first radial waveguide comprising a first base plate and a first slot plate defining a first waveguide cavity therebetween, the first slot plate having a plurality of first radiating slots formed therethrough, the first radial waveguide being partitioned into a plurality of first waveguide sectors by a plurality of azimuthally spaced first partition walls, wherein each first partition wall of the plurality of azimuthally spaced first partition walls extends radially over less than a radial extent of the first waveguide cavity, each first waveguide sector of the plurality of first waveguide sectors comprises a first feed probe connected to the beamsteering device and is configured to introduce a corresponding beamsteering signal of the plurality of beamsteering signals into the first waveguide sector and cause the corresponding beamsteering signal to radiate through a number of radiating slots of the plurality of first radiating slots corresponding to the first waveguide sector, thereby generating the OAM electromagnetic beam or a first beam component of the OAM electromagnetic beam.

2. The system of claim 1, wherein the steering conditions comprise an azimuth angle steering range ranging from about 0° to about 360°.

3. The system of claim 1, wherein the steering conditions comprise an elevation angle steering range ranging from about 0° to about 10°.

4. The system of claim 1, wherein the first waveguide cavity extends radially between an inner edge and an outer edge of the first radial waveguide, and wherein each first partition wall extends radially from one of the inner edge and the outer edge and terminates at a distance from the other one of the inner edge and the outer edge.

5. The system of claim 1, wherein the first radial waveguide is configured to generate the first beam component of the OAM electromagnetic beam from a first subset of the plurality of beamsteering signals, and wherein the antenna structure further comprises:
a second radial waveguide azimuthally enclosing the first radial waveguide, the second radial waveguide comprising a second base plate and a second slot plate defining a second waveguide cavity therebetween, the second slot plate having a plurality of second radiating slots formed therethrough, the second radial waveguide being partitioned into a plurality of second waveguide sectors by a plurality of azimuthally spaced second partition walls, wherein each second partition wall of the plurality of azimuthally spaced second partition walls extends radially over less than a radial extent of the second waveguide cavity, each second waveguide sector of the plurality of second waveguide sectors comprises a second feed probe connected to the beamsteering device and is configured to introduce a corresponding beamsteering signal of a second subset of the plurality of beamsteering signals into the second waveguide sector and cause the corresponding beamsteering signal to radiate through a number of radiating slots of the plurality of second radiating slots of the second radial waveguide corresponding to the second waveguide sector, thereby generating a second beam component of the OAM electromagnetic beam.

6. The system of claim 5, wherein the first slot plate of the first radial waveguide defines a first radiating surface, the second slot plate of the second radial waveguide defines a second radiating surface, and the first radiating surface and the second radiating surface are substantially coplanar with each other.

7. The system of claim 5, wherein the second beam component of the OAM electromagnetic beam carries one or more second OAM modes of higher order than one or more first OAM modes carried by the first beam component of the OAM electromagnetic beam.

8. The system of claim 5, wherein a plurality of first feed probes of the first radial waveguide are located at a plurality of first azimuthal positions along a first circular array, a plurality of second feed probes of the second radial waveguide are located at a plurality of second azimuthal positions along a second circular array, and each first azimuthal position is different from each second azimuthal position.

9. The system of claim 8, wherein the n^{th} first azimuthal position φ_{1,n} is given by 2π(n−1)/N₁, n₁ is a number of first feed probes in the first radial waveguide, the n^{th} second azimuthal position φ_{2,n} is given by π(2n−1)/N₂, and N₂ is a number of second feed probes in the second radial waveguide.

10. The system of claim 1, wherein the first radial waveguide is configured to generate the first beam component of the OAM electromagnetic beam, and the antenna structure further comprises a central radial waveguide nested within the first radial waveguide, the central radial waveguide comprising:
a third base plate and a third slot plate defining a third waveguide cavity therebetween, third the slot plate having a plurality of third radiating slots formed therethrough; and
a third feed probe connected to the beamsteering device to introduce a corresponding one of plurality of the beamsteering signals into the central radial waveguide and cause the corresponding beamsteering signal to radiate through the third radiating slots of the central radial waveguide and generate an unsteered beam component of the OAM electromagnetic beam.

11. A method of generating and steering an orbital angular momentum (OAM) electromagnetic beam, comprising:
generating a plurality of beamforming signals by modulating a plurality of input signals in accordance with beamforming phase shifts related to a mode content of the OAM electromagnetic beam;
generating a plurality of beamsteering signals by modulating the plurality of beamforming signals in accordance with beamsteering phase shifts related to steering conditions for the OAM electromagnetic beam; and
emitting the OAM electromagnetic beam according to the steering conditions by feeding the plurality of beamsteering signals to an antenna structure comprising a first radial waveguide, the first radial waveguide comprising a first base plate and a first slot plate defining a first waveguide cavity therebetween, the first slot plate having a plurality of first radiating slots formed therethrough, the first radial waveguide being partitioned into a plurality of first waveguide sectors by a plurality of azimuthally spaced first partition walls, wherein each first partition wall of the plurality of azimuthally spaced first partition walls extends radially over less than a radial extent of the first waveguide cavity, wherein emitting the OAM electromagnetic beam comprises introducing a corresponding one of the plurality of beamsteering signals into each first waveguide sector to cause the corresponding beamsteering signal to radiate through a number of radiating slots of the plurality of first radiating slots corresponding to the first waveguide sector.

12. The method of claim 11, wherein:
the first radial waveguide is configured to generate a first beam component of the emitted OAM electromagnetic beam from a first subset of the plurality of beamsteering signals,
the antenna structure further comprises a second radial waveguide azimuthally enclosing the first radial waveguide, the second radial waveguide comprising a second base plate and a second slot plate defining a second waveguide cavity therebetween, the second slot plate having a plurality of second radiating slots formed therethrough, the second radial waveguide being partitioned into a plurality of second waveguide sectors by a plurality of azimuthally spaced second partition walls, wherein each second partition wall of the plurality of azimuthally spaced second partition walls extends radially over less than a radial extent of the second waveguide cavity; and
emitting the OAM electromagnetic beam further comprises introducing a corresponding one of a second subset of the plurality of beamsteering signals into each second waveguide sector of the second radial waveguide to cause the corresponding beamsteering signal to radiate through a number of radiating slots of the second radiating slots of the second radial waveguide corresponding to the second waveguide sector, thereby generating a second beam component of the emitted OAM electromagnetic beam.

13. The method of claim 12, wherein the first slot plate of the first radial waveguide defines a first radiating surface, wherein the second slot plate of the second radial waveguide defines a second radiating surface, and wherein the method further comprises providing the first radiating surface and the second radiating surface in a substantially coplanar arrangement.

14. The method of claim 12, further comprising setting or adjusting the mode content of the OAM electromagnetic beam to provide that the second beam component of the OAM electromagnetic beam carries one or more second OAM modes of higher order than one or more first OAM modes carried by the first beam component of the OAM electromagnetic beam.

15. The method of claim 11, wherein:
the first radial waveguide is configured to generate a first beam component of the emitted OAM electromagnetic beam;
the antenna structure further comprises a central radial waveguide nested within the first radial waveguide, the central radial waveguide comprising a third base plate and a third slot plate defining a third waveguide cavity therebetween, the third slot plate having a plurality of third radiating slots formed therethrough; and
emitting the OAM electromagnetic beam further comprises introducing a corresponding one of the plurality of beamsteering signals into the central radial waveguide to cause the corresponding beamsteering signal to radiate through the third radiating slots of the central radial waveguide and generate an unsteered beam component of the emitted OAM electromagnetic beam.

16. A system for generating and steering an orbital angular momentum (OAM) electromagnetic beam, comprising:
a beamforming device configured to receive a plurality of input signals and output a plurality of beamforming signals by modulating the plurality of input signals in accordance with beamforming phase shifts related to a mode content of the OAM electromagnetic beam;
a beamsteering device configured to receive the plurality of beamforming signals and output a plurality of beamsteering signals by modulating the plurality of beamforming signals in accordance with beamsteering phase shifts related to steering conditions for the OAM electromagnetic beam; and
an antenna structure comprising:
a first radial waveguide comprising a first base plate and a first slot plate defining a first waveguide cavity therebetween, the first slot plate having a plurality of first radiating slots formed therethrough, the first radial waveguide being partitioned into a plurality of first waveguide sectors by a plurality of azimuthally spaced, radially extending first partition walls, each first waveguide sector comprising a first feed probe connected to the beamsteering device and configured to introduce a corresponding one of a first subset of the plurality of beamsteering signals into the first waveguide sector and cause the corresponding beamsteering signal to radiate through a number of radiating slots of the first radiating slots corresponding to the first waveguide sector, thereby generating a first beam component of the OAM electromagnetic beam; and
a second radial waveguide azimuthally enclosing the first radial waveguide, the second radial waveguide comprising a second base plate and a second slot plate defining a second waveguide cavity therebetween, the second slot plate having a plurality of second radiating slots formed therethrough, the second radial waveguide being partitioned into a plurality of second waveguide sectors by a plurality of azimuthally spaced, radially extending second partition walls, each second waveguide sector comprising a second feed probe connected to the beamsteering device and configured to introduce a corresponding one of a second subset of the plurality of beamsteering signals into the second waveguide sector and cause the corresponding beamsteering signal to radiate through a number of radiating slots of the second radiating slots corresponding to the second waveguide sector, thereby generating a second beam component of the OAM electromagnetic beam,
wherein the first slot plate defines a first radiating surface, the second slot plate defines a second radiating surface, and the first radiating surface and the second radiating surface are substantially coplanar with each other.

17. The system of claim 16, wherein a plurality of first feed probes of the first radial waveguide are located at a plurality of first azimuthal positions along a first circular array, a plurality of second feed probes of the second radial waveguide are located at a plurality of second azimuthal positions along a second circular array, and each first azimuthal position is different from each second azimuthal position.

18. The system of claim 17, wherein the n^{th} first azimuthal position φ_{1,n} is given by 2π(n−1)/N₁, N₁ is a number of first feed probes in the first radial waveguide, and the n^{th} second azimuthal position φ_{2,n} is given by π(2n−1)/N₂, and N₂ is a number of second feed probes in the second radial waveguide.

19. The system of claim 16, wherein each first partition wall extends radially over less than a radial extent of the first waveguide cavity to provide partial isolation between the plurality of first waveguide sectors, or wherein each second partition wall extends radially over less than a radial extent of the second waveguide cavity to provide partial isolation between the plurality of second waveguide sectors.

20. The system of claim 16, wherein the antenna structure further comprises a central radial waveguide nested within the first radial waveguide, the central radial waveguide comprising:
a central base plate and a central slot plate defining a central waveguide cavity therebetween, the central slot plate having a plurality of central radiating slots formed therethrough; and
a central feed probe connected to the beamsteering device and configured to introduce a corresponding one of the plurality of beamsteering signals into the central radial waveguide and cause the corresponding beamsteering signal to radiate through the central radiating slots and generate an unsteered component of the OAM electromagnetic beam,
wherein the central slot plate defines a central radiating surface that is substantially coplanar with the first radiating surface and the second radiating surface.
